(19) United States
(12) Patent Application Publication
(10) Pub. No.: US 2016/0381501 A1
(43) Pub. Date: Dec. 29, 2016

(54) System and Method for Locationally Aware Communication

(71) Applicants: Louis Ballezzi, Philadelphia, PA (US); Michael Goldberg, Brookline, MA (US); Adam Goldberg, Toronto (CA)

(72) Inventors: Louis Ballezzi, Philadelphia, PA (US); Michael Goldberg, Brookline, MA (US); Adam Goldberg, Toronto (CA)

(21) Appl. No.: 15/193,426

(22) Filed: Jun. 27, 2016

Related U.S. Application Data
(60) Provisional application No. 62/186,079, filed on Jun. 29, 2015.

(51) Int. Cl. H04W 4/02; H04L 29/08; H04L 12/58

(52) U.S. Cl. CPC H04W 4/021; H04L 51/32; H04L 67/22; H04L 67/18; H04L 51/04; H04L 67/306; H04L 67/26

(57) ABSTRACT

A system and method for locationally aware communication that does not reveal a user's exact location to any other user. Users interact with client applications installed on their computing devices, which are connected to one or more remote serves. Users may determine when certain other users are nearby specified geographic areas, may communicate with others, and may view, send, and receive invitations to events. Communication may be transmitted to individual recipients or to groups of recipients. Invitations may be transmitted to specified invitees or to broader groups of users. Users may define parameters controlling the extent to which information about their locations may be shared with others.

### CROSS-REFERENCE TO RELATED APPLICATIONS

This application claims the benefit of U.S. Provisional Patent Application 62/186,079 filed Jun. 29, 2015 entitled “System and Method for Locationally Aware Communication” the entire contents of which is hereby incorporated by reference in its entirety.

### BACKGROUND OF THE INVENTION

Individuals use a variety of technological means to communicate with their friends, as well as to plan social meetings with their friends. Popular methods include software applications that provide real-time communication capabilities via text (including instant messaging, email, and social media posts), audio, and/or video. These applications often run on personal computer and mobile devices, such as smart phones. Many such applications allow users to communicate with multiple friends simultaneously, in a group discussion format. Using such technological means, individuals may commence an impromptu conversation with one or more friends or they may send their friends messages requesting real-time conversations or proposing a real-world gathering, such as a party. Many individuals currently also make use of digital calendars to keep track of appointments and to send calendar invitations to their friends for social gatherings.

With the increasing popularity of social media platforms, many individuals now communicate with their friends by posting a series of static status messages to their social media profile pages. Such status messages may refer to their present location or their future plans. The content of any such status messages may prompt a friend of the posting individual to respond or otherwise reach out to the posting individual and, potentially, get together with the posting individual in the real world.

At the same time, many of the devices upon which users frequently run such applications and access such social media platforms feature locational capabilities, through which the device determines its location (and, by proxy, the location of its user). These locational capabilities allow individuals to share their locations with others (in various forms including addresses, place names, or coordinates). Sharing one's location with friends can have great utility, specifically because it can facilitate real-world socialization. If, for example, an individual shares that he is located at position A, any of his friends who have access to that shared information and who are also near position A can communicate with the individual and, if they choose, meet in person.

Certain social media platforms allow users to include their present locations in their static status posts. Such posts can be informative and useful to the user and his friends who view the post, but they are of limited utility because they require the user to take explicit action to include his location in a post, and the location included in the post can quickly grow stale as soon as the user relocates to a different location.

Other existing applications actively keep track of a user's position, allowing the user and his or her friends to access up-to-date locational information. Such applications have certain advantages when compared to static status posts. Specifically, they provide useful information to users without explicit input from those users. That is, by running in the background of a user's device, these applications update themselves with regard to the user's location throughout the day and without requiring the user to remember to share his location or make any additional effort to do so. Such applications may be of particular use to, for example, spouses who wish to have immediate access to each other's locations or parents who wish to be able to locate their children quickly and with great accuracy.

Despite its utility, however, location-sharing technology raises significant privacy concerns for many individuals. Many individuals may not wish for their exact locations at any particular time to be accessible by others. An alternative approach, therefore, making use of passive location-sharing technology while protecting the privacy of users, would be of great utility to users.

### BRIEF SUMMARY OF THE INVENTION

An embodiment of the invention is a system and method that allows a user to know when other users who are socially connected to the user (that is, his or her friends and acquaintances) are nearby specified locations, and to communicate with such other users, without exposing the exact location of any user to any other user. The system is comprised of a remote operations center, featuring one or more servers, and client devices that run a client application and connect to such remote operations center over the internet or another network. Each client device calculates its location using one or more internal sensors and transmits such location to the system's servers, which log such location in a database. As each client device changes location, it reports updated locations to the system's servers, which update the system's database.

In such embodiment of the invention, the client application allows users to determine when their friends and acquaintances are nearby by interacting with a map interface to define a query comprised of a center point and search radius. Users can search the map interface visually (by navigating the visual map) or by specifying an address or landmark to act as the query center point. The client application submits the query to the system's servers, which process the query by: accessing the system's database; identifying those other users of the system who are denoted in the database as being connected to the querying user; identifying, from within the list of those other users, those whose account settings permit the querying user to be informed of when such other users are nearby; accessing the most recent locations of client devices associated with such subset of other users; calculating which of those stored locations are within the geographic area specified by the query; generating a list of the user accounts associated with such stored locations; and transmitting such list to the client device of the querying user. The client application informs the user of how many of such other users are within the queried geographic area and, by tapping a button provided within the client application, a user can then see the identities of such other users (but, in such embodiment, not the exact location of any of those other users). The system thus allows users to learn when others are nearby without disclosing the exact locations of users to each other, balancing the privacy preferences of users with the utility of location sharing.

In an embodiment, the client application permits a user to tailor his or her privacy preferences by defining one or more parameters to specify which other users can use the system to determine when he or she is likely located within a queried geographic area. Such parameters may include: the selection of whether such user should be included in vicinity queries performed by any other users of the application; the selection, on a user-by-user basis, of whether such user should be included in vicinity queries performed by particular other users; the selection of whether such user should be included in vicinity queries when such user is located at one or more particular locations; or the selection of whether such user should be included in vicinity queries conducted at particular times. Such defined parameters are transmitted by the client application to the system's servers, which store such parameters and apply them to user queries.

In an embodiment, each user of the client application can specify one or more geographic locations to be stored in the system's database in relation to such user's account, as well as one or more time periods during which such specified geographic locations should be used by the system in place of any location detected by the user's client device. This feature enables users to reap the benefit of receiving location-specific messages and invitations from others who use the application who may search within the alternate vicinity specified by the user.

An embodiment of the invention also includes a messaging client, which allows users to communicate with each other via text, video, audio, still images, or other digital data. A user may send a message to a single other user, to multiple other users as a group, or to multiple other users individually (that is, as a series of individual messages).

In an embodiment, the client application also permits users to transmit invitations to events, which invitations may include text, video, audio, still images, or other digital data. Users sending invitations may specify when the events relating to such invitations are private or public. In such embodiment, invitations to private events are viewable only by the recipients specified by the sender. In contrast invitations to public events are viewable by all users by visual review or search of either: (1) a mapping interface within the client application (upon which public events are marked by visual elements overlaid on the map location of the applicable event) or (2) a listing of invitations to public events that the client application makes available to users. The invention thus enables users to easily learn about their local social context, that is, users can easily learn who is nearby and what is occurring nearby.

Messages and invitations sent through an embodiment of the invention may be transmitted outside of the system by making use of one or more additional communication protocols, such as SMS or email, so that users can send information to non-users from within the client application. For example, if a user composes a message or invitation and selects a group of recipients that include: (1) other users of the client application, (2) individuals who do not use the client application but for whom the sender has a telephone number, and (3) individuals who do not use the client application but for whom the sender has an email address, the system in such embodiment will: (1) transmit the message or invitation to the client application running on the client device(s), if any, on which the user accounts of recipients who use the client application are logged in, (2) route the message or invitation to the SMS application of the sender's device, or send the message or invitation via SMS, for those recipients who do not use the client application but for whom the sender has a telephone number, and (3) route the message or invitation to the email application of the sender's device, or send the message or invitation via email, for those recipients who do not use the client application but for whom the sender has an email address. Additional communication protocols can be added in other embodiments to provide users with further ways to communicate with others (regardless of whether those others use the client application). Moreover, in additional embodiments, a user of the client application can specify the order in which additional communication protocols are to be prioritized (e.g., first SMS, second email versus first email, second SMS).

Certain embodiments of the invention may include advertisements displayed or otherwise distributed through the client application. Such advertisements may include visual and/or audible components and may or may not be distributed with regard to the location of users of the client application. For example, in an embodiment, an advertisement for an event that is to occur at location A (e.g., a concert venue) may be distributed to a user of the application who is located near location A at a time prior to the occurrence of such advertised event. In additional embodiments, the selection of which advertisements are to be distributed to particular users of the application may give weight to the preferences and interests expressed by such users.

In one embodiment, advertisements may be displayed within a dedicated portion of the screen on which the client application is being viewed. In another embodiment, advertisements may be presented as visual markers on the mapping interface provided within the client application. In such an embodiment, the user may be able to obtain additional information about such advertisement by selecting it from within the application interface.

The pricing charged for such advertisements may take into account several location-based factors. In one embodiment, the cost charged to an advertiser may increase in relation to the concentration of advertisements to be displayed with respect to a specified locational area. For example, if there are 10 advertisements that are to be displayed near location A and 5 advertisements that are to be displayed near location B, a higher price may be charged to those advertisers who wish to display advertisements near location A. In another embodiment, the cost charged to an advertiser may increase in relation to the concentration of users of the application near the location at which such advertisement is to be displayed. For example, if there are 100 users near location X and 10 users near location Y, a higher price may be charged to those advertisers who wish to display advertisements near location X. In another embodiment, advertisers may be permitted to bid different amounts to affect the probability that their advertisements will be displayed. For example, in such an embodiment, the service may limit the number of advertisements that will be displayed by the client application at a particular moment within a certain vicinity. If two advertisers wish to display advertisements to application users who are near location Q, each such advertiser may be permitted to bid for the right to have its advertisement displayed. In such an embodiment, the frequency with which an advertisement is displayed may be related to the relative size of the bid submitted by the sponsoring advertiser.

In further embodiments, advertisers may be charged with respect to the number of application users who interact with (or “click through”) their advertisements that may be displayed within the client application, including on top of the application's mapping interface.

### BRIEF DESCRIPTION OF THE SEVERAL VIEWS OF THE DRAWING

FIG. 1 is a schematic of an embodiment of the system.

FIG. 2 is a schematic of an embodiment of a client device.

FIG. 3 illustrates the collection of location information from a client device.

FIG. 4 illustrates the updating of location information from a client device.

FIG. 5 illustrates a flow of information for an example query of nearby users who are denoted as connected to a user in the system's database.

FIG. 6 illustrates an example query of nearby users who are denoted as connected to a user in the system's database.

FIG. 7 illustrates an alternative example query of nearby users who are denoted as connected to a user in the system's database.

FIG. 8 illustrates a flow of information for sending an individual message.

FIG. 9 illustrates a flow of information for sending a group message to multiple recipients.

FIG. 10 illustrates a flow of information for sending an individual message to multiple recipients.

FIG. 11 illustrates a flow of information for sending a private invitation.

FIG. 12 illustrates a flow of information for sending and retrieving a public invitation.

FIG. 13 is a view of the main home screen of the client application interface.

FIG. 14 is a view of the main home screen of the client application interface with search radius increased.

FIG. 15 is a view of the main home screen of the client application interface with search radius decreased.

FIG. 16 is a view of a search screen for a location or address.

FIG. 17 is a view of a search screen for a location or address, with a location entered.

FIG. 18 is a view of the main home screen after selection of a searched location.

FIG. 19 is a view of the main home screen after a selected location is moved by the user.

FIG. 20 is a view of the client application interface after a user selects “Connect with Nearby Friends”.

FIG. 21 is a view of the client application interface after a user selects a nearby contact to whom the user is denoted as being connected in the system's database.

FIG. 22 is a view of the client application interface after a user selects a contact to whom the user is denoted as being connected in the system's database who is not nearby.

FIG. 23 is a view of the client application interface after a user selects nearby and non-nearby contacts to whom the user is denoted as being connected in the system's database.

FIG. 24 is a view of the client application interface after a user selects to message multiple contacts to whom the user is denoted as being connected in the system's database.

FIG. 25 is a view of the client application interface after a user selects to message multiple contacts to whom the user is denoted as being connected in the system's database, as part of a group conversation.

FIG. 26 is a view of the client application interface after a user selects to send a message separately to multiple contacts to whom the user is denoted as being connected in the system's database.

FIG. 27 is a view of the client application interface after a user selects a contact to whom the user is not denoted as being connected in the system's database.

FIG. 28 is a view of the client application interface after a user selects to message a contact to whom the user is not denoted as being connected in the system's database.

FIG. 29 is a view of the client application interface after a user selects both contacts to whom the user is denoted as being connected in the system's database and contacts to whom the user is not denoted as being connected in the system's database.

FIG. 30 is a view of the client application interface after a user selects to send an invitation to one or more contacts.

FIG. 31 is a view of the client application interface in which a user specifies an alternate location, and a time period during which such alternate location should be used, at which the system will treat the user as being located.

FIG. 32 is a view of the client application interface showing a visual marker of an alternate location at which the system will treat the user as being located.

FIG. 33 is a view of the client application interface showing a side menu for navigation among sections of the client application, with the Home section selected.

FIG. 34 is a view of the client application interface showing a side menu for navigation among sections of the client application, with the Messages section selected.

FIG. 35 is a view of the client application interface showing the main Messages section.

FIG. 36 is a view of the client application interface allowing a user to select a person with whom to start a new message thread.

FIG. 37 is a view of the client application interface allowing a user to select multiple people with whom to start a new group message thread.

FIG. 38 is a view of the client application interface allowing a user to mute or leave a specific message thread.

FIG. 39 is a view of the client application interface allowing a user to mute or leave multiple message threads.

FIG. 40 is a view of the client application interface showing a message thread involving two users.

FIG. 41 is a view of the client application interface showing a message thread involving a group.

FIG. 42 is a view of the client application interface showing a message passed through to the client device's SMS application.

FIG. 43 is a view of the client application interface showing a message passed through to the client device's SMS application and sent.

FIG. 44 is a view of the client application interface showing a side menu for navigation among sections of the client application, with the Invitations section selected.

FIG. 45 is a view of the client application interface showing received invitations.

FIG. 46 is a view of the client application interface showing sent invitations.

FIG. 47 is a view of the client application interface showing public invitations.

FIG. 48 is a view of the client application interface for the creation of an invitation.

FIG. 49 is a view of the client application interface for the selection of recipients of an invitation.

FIG. 50 is an alternate view of the client application interface for the selection of recipients of an invitation.

FIG. 51 is a view of the client application interface for the selection of recipients of an invitation, with certain recipients selected.

FIG. 52 is an alternate view of the client application interface for the selection of recipients of an invitation, with certain recipients selected.

FIG. 53 is a view of the client application interface for the creation of an invitation, with a recipient selected.

FIG. 54 is a view of the client application interface showing a side menu for navigation among sections of the client application, with the Friends section selected.

FIG. 55 is a view of the client application interface showing the main Friends section.

FIG. 56 is an alternate view of the client application interface showing the main Friends Section, showing only contacts to whom the user is denoted as being connected in the system's database.

FIG. 57 is an alternate view of the client application interface showing the main Friends Section, showing only contacts to whom the user is not denoted as being connected in the system's database.

FIG. 58 is a view of the client application interface showing the main Friends Section, including a search tool by which the user can filter contacts.

FIG. 59 is a view of the client application interface showing the main Friends Section, in which one contact is selected.

FIG. 60 is a view of the client application interface showing the main Friends Section, in which two contacts are selected.

FIG. 61 is a view of the client application interface showing a side menu for navigation among sections of the client application, with the Settings section selected.

FIG. 62 is a view of the client application interface showing the main Settings section.

FIG. 63 is a view of the client application interface showing the main Profile section.

FIG. 64 is a view of the client application interface showing the Edit Profile section.

FIG. 65 is a view of the client application interface showing the Account section.

FIG. 66 is a view of the client application interface showing the Notification Settings section.

FIG. 67 is a view of the client application interface showing the Edit Invisibility section.

FIG. 68 is a view of the client application interface showing the Custom Invisibility section.

FIG. 69 is an alternate view of the client application interface showing the Custom Invisibility section, with certain settings changed.

FIG. 70 is a view of the client application interface showing the Locational Invisibility section.

FIG. 71 is a view of the client application interface showing the Total Invisibility section.

### DETAILED DESCRIPTION OF THE INVENTION

The following is a detailed description of multiple embodiments of the disclosed invention, comprising a digital communication system including central servers and individual client applications running on devices controlled by users of the system, which system enables users to determine when certain other users of the system are nearby, and to communicate with other users. Certain embodiments may never disclose the exact location of any user to any other user. Certain embodiments may feature advertisements, which may be location-based.

An embodiment of the invention is a system featuring an application and providing a service that enables users to know when other users, to whom they are denoted as connected within such system, are nearby specified locations, without ever exposing the exact location of any user to any other user, and to communicate with users and others. The client application runs on one or more device(s) in possession of the user. On such a device, and with the permission of the user, the application determines the location of that device (and, by proxy, the location of the user). In a preferred embodiment, the application retrieves the location of the device from locational services already running on such device, which services are accessible to third-party applications such as the embodiment application. The location of the device may be determined to varying degrees of accuracy, and may be based upon a variety of measurements relating to cellular telephone towers, wireless internet gateways, or global positioning system signals.

Regardless of the degree of accuracy, however, such location is transmitted from the user's device to one or more servers running the service, which log such location for such device in databases of the system. As such device changes location, the application sends updated location information to such servers, which in turn update the databases of the system to keep current locational information regarding such device. Such location determination, transmission, and recording occur without the need for the user to interact with the system in order to trigger any update or other posting or signaling of the user's location.

The invention disclosed herein includes a method of enabling users to know when other users, to whom they are denoted as connected within such system, are nearby specified locations, without, in certain embodiments, ever exposing the exact location of any user to any other user, and to communicate with users and others. Users sign up for the service provided by the invention by creating accounts for themselves. Information about each user that is to be used in the functioning of the service provided by the invention is stored in one or more databases of the system for purposes of the functions described below.

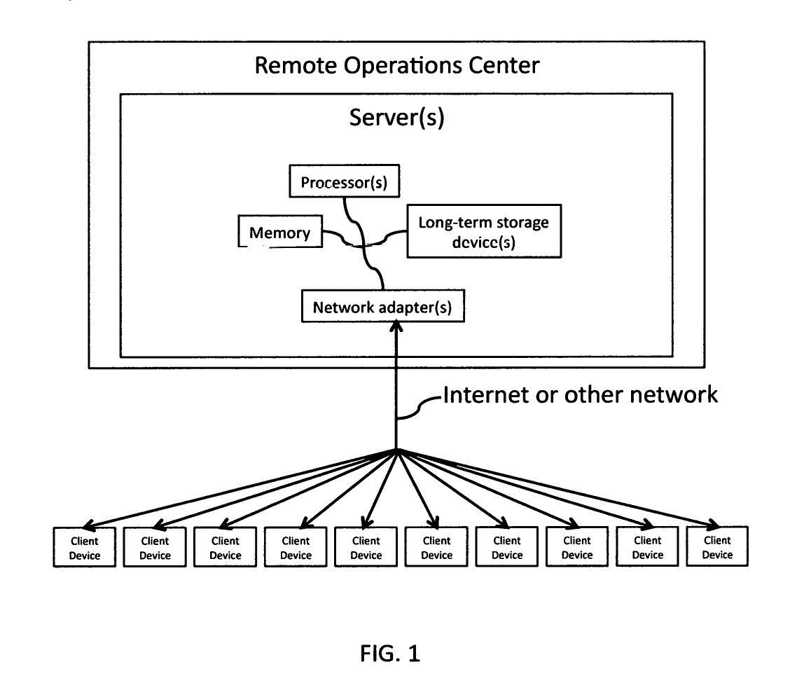

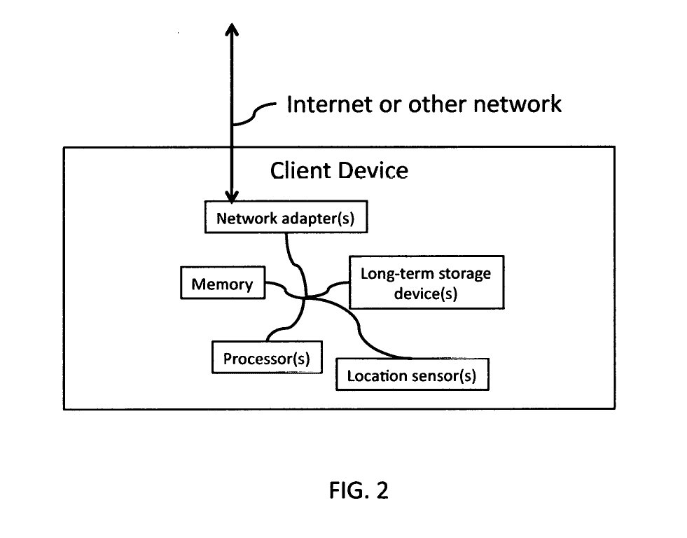

As shown in FIG. 1, a preferred embodiment comprises a system featuring a remote operations center, which center is comprised of one or more servers that can connect to the internet or another network, and client devices running the client application and that can connect to the internet or such other network. The server(s) included within the remote operations center are comprised of one or more processors, memory, one or more long-term storage devices, and one or more network adapters connecting such servers to the internet or another network. As shown in FIG. 2, in such embodiment, each client device running the client application features one or more processors, memory, one or more long-term storage devices, one or more network adapters, and one or more sensors from which the location of such device can be determined.

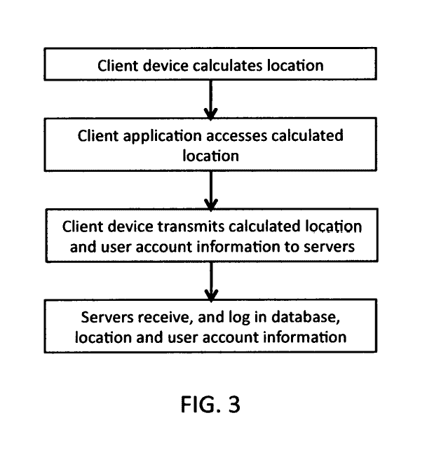

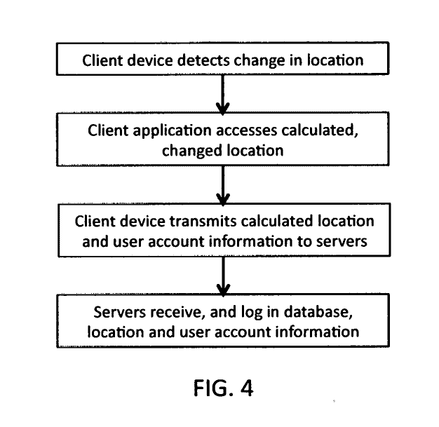

Each client device running the application calculates the location of such device using one or more built-in sensors, which may include, but are not limited to, global positioning system sensors, cellular radio transmitters and receivers, Wi-Fi radio transmitters and receivers, and Bluetooth radio transmitters and receivers. As summarized in FIG. 3, upon determining the location of the device, the client device running the application transmits such locational information, together with the identity of the account logged into the application on such client device, over the internet or another network, to the system's server(s). The server(s) receive such data through the internet or such other network and log it in a database stored on one or more of the long-term storage devices connected to the server(s). Through repetition of this procedure on numerous client devices running the application, such database will include locational information for the network of user accounts created within the application. As summarized in FIG. 4, if and when the location of a client device changes, such client device detects such change using one or more sensors and transmits such changed locational information, together with the identity of the account logged into the application on such client device, over the internet or another network, to the system's server(s). The server(s) receive such data through the internet or such other network and log it in the database to update such database with respect to the location of the applicable client device. In this way, the database receives periodic updates regarding the locations of the devices running the client application.

In a preferred embodiment, the application running on a client device provides a visual mapping interface within the application, which functions as follows: within the application, the user is presented with a map, which may initially be centered about the user's own location; the graphical interface also features tools that allow the user to: (1) move the center point of the area represented by the map and (2) specify a search radius (from within a range bounded by a prescribed maximum and minimum) to be applied about the selected map center point. In a preferred embodiment, a user may select a center point visually by moving the displayed map via the interface provided in the application or by specifying an address or location to serve as the center point.

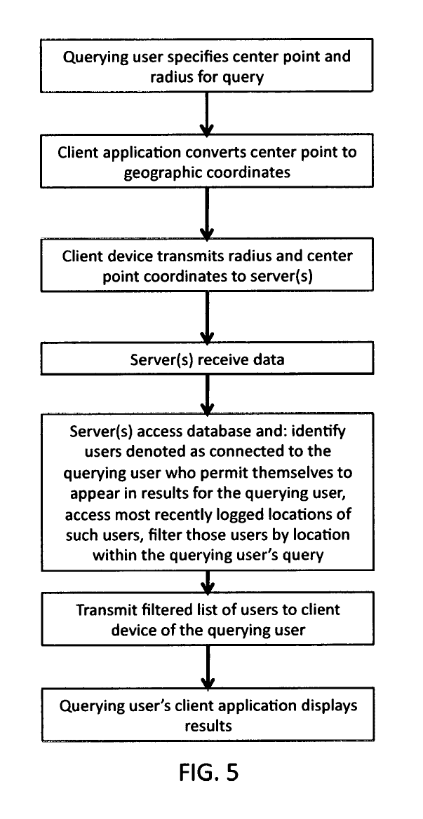

As summarized in FIG. 5, a user of the client application can specify a query, comprising a center point and a radius defining a geographic area. The client application converts the center point and radius specified by the user into a set of geographic coordinates and transmits such information to the server(s), which receive such query and process it. The processing of such query is comprised of: accessing the system's database; identifying those other users of the system who are denoted in the database as being connected to the querying user; identifying, from within the list of those other users, those whose account settings permit the querying user to be informed of when such other users are nearby; accessing the most recent locations of client devices associated with such subset of other users; calculating which of those stored locations are within the geographic area specified by the query; generating a list of the user accounts associated with such stored locations; and transmitting such list to the client device of the querying user.

In such embodiment, upon receipt of such list from the server(s), the client application running on the querying user's client device displays to the querying user an indication of the number and/or identity of such other users who have client devices for which the most recently stored locations are within the queried geographic area. In this way, the above-described embodiment manipulates locational data received from a multiplicity of users of the system to present to a querying user a list of other users who are likely located within the queried geographic area and who are denoted in the system's database as being connected to the querying user. In a preferred embodiment, the client application that receives such list displays an integer to the querying user, which integer represents the number of such other users who are included in such list. In a preferred embodiment, the querying user can also access, through the client application, the identities of those other users included in such list. In this way, the querying user can use the embodiment to determine which other users, to whom he or she is denoted as connected within such system, are likely located within the queried geographic area. Additional embodiments permit the querying user to command the client application to further manipulate the list of other users who are likely located within the queried geographic area by ordering, ranking, or filtering such list. In a preferred embodiment, each time the user changes the selected map center point or search radius, the client application transmits a query using those changed parameter(s) to the server(s) for processing.

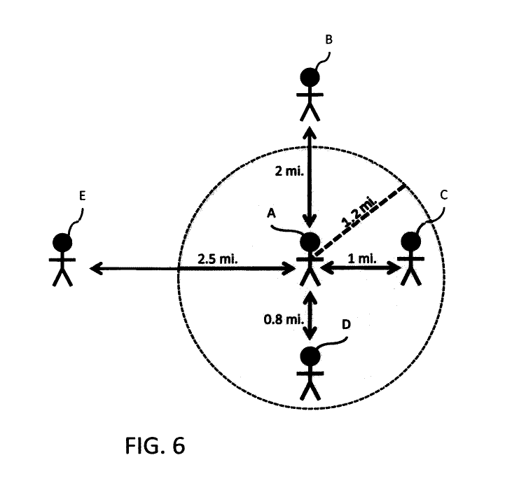

FIG. 6 illustrates an example query, and the corresponding results of such query. In such example, User A is denoted in the system as connected to Users B, C, D, and E, and the user accounts of Users B, C, D, and E each are set to permit User A to be informed when each respective user is nearby. The most recent location logged in the system for User B is located 2 miles from User A; the most recent location logged in the system for User C is located 1 mile from User A, the most recent location logged in the system for User D is located 0.8 miles from User A, and the most recent location logged in the system for User E is located 2.5 miles from User A. User A selects his own location as the map center point for the query and selects a search radius of 1.2 miles. The locations logged in the system for Users C and D satisfy the query because those locations fall within the queried area. The locations logged in the system for users B and E do not satisfy the query.

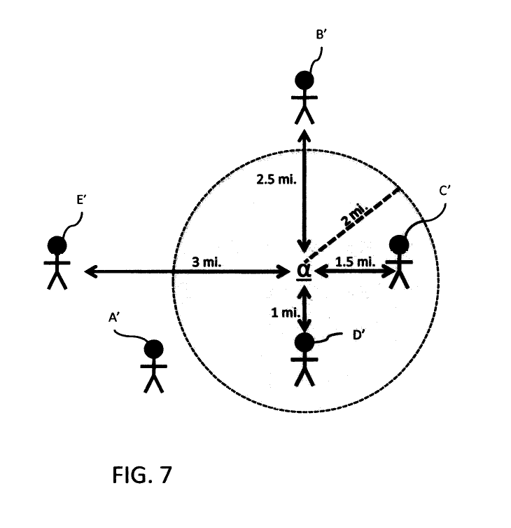

FIG. 7 illustrates an alternate example query, and the corresponding results of such alternate query. In such example, User A′ is denoted in the system as connected to Users B′, C′, D′, and E′, and the user accounts of Users B′, C′, D′, and E′ each are set to permit User A′ to be informed when each respective user is nearby. The most recent location logged in the system for User B′ is located 2.5 miles from location a; the most recent location logged in the system for User C′ is located 1.5 miles from location a, the most recent location logged in the system for User D′ is located 1 mile from location a, and the most recent location logged in the system for User E′ is located 3 miles from location a. User A′ selects location a as the map center point for the query and selects a search radius of 2 miles. The locations logged in the system for Users C′ and D′ satisfy the query because those locations fall within the queried area. The locations logged in the system for users B′ and E′ do not satisfy the query.

In a preferred embodiment, the number of such other users who are nearby the queried center point is presented by the application visually as an integer to the querying user. Additional embodiments may employ alternative means of informing the querying user about the number of such other users who are nearby the queried center point. For example, the application could display differing colors or shading upon the map interface, with certain colors or concentration of shading representing different numbers of such other users. In other embodiments, the number of such other users who are nearby the queried center point could be presented by the application to the querying user by any other visual, audible, or physical means.

In a preferred embodiment, the visual interface of the application also features a button that, when selected by the querying user, informs such user of the identity of those other users, to whom the querying user is denoted as connected within the system, who have current locations stored in the database that are within the location area specified by the querying user. However, such embodiment of the application never informs the querying user of the exact location of any other user of the system. In this way, the system provides utility to the querying user without disclosing the exact location of anyone else. This restriction of such embodiment balances the privacy of all users with the utility that users can derive from knowing when other users are nearby specified locations.

In a preferred embodiment, each user of the client application can specify which other users, who are denoted in the system's database as being connected to such user, can use the embodiment to determine when he or she is likely located within a queried geographic area. To do so, the user specifies parameters within the client application running on his or her device defining one or more of the following: (1) whether such user should be included in any vicinity queries performed by other users of the application (meaning that no other user will be able to know when such user is within the other user's specified search vicinity); (2) whether such user should, on a user-by-user basis, be included in vicinity queries performed by particular other users; (3) whether such user should be included in vicinity queries when such user is located at one or more particular locations (meaning that, whenever such user is near such a specified location, some or all other users will be unable to know when such user is within such other users' specified search vicinity); and (4) whether such user should be included in vicinity queries conducted at particular times (meaning that, during such time periods, some or all other users will be unable to know when such user is within such other users' specified search vicinity). Each such parameter specified by a user is transmitted from such user's client application to the system's server(s), which parameter is then stored in the system's database. Each such stored parameter is applied as a constraint on vicinity queries involving the user account for which such parameter is stored to determine whether such user will be included in any results list generated by such vicinity query. In this way, such parameters, defined by a user for his or her user account, are applied to vicinity queries to manipulate the locational data stored within the system's database.

In a preferred embodiment, each user of the client application can specify one or more geographic locations to be stored in the system's database in relation to such user's account, as well as one or more time periods during which such specified geographic locations should be used. In such embodiment, the client application transmits such specified locations and time periods to the system's server(s), which store such data in the system's database. For any vicinity query conducted during such a specified time period, the applicable specified location is used in place of any locational information otherwise transmitted by the user's client device. In this way, the client application permits each user to alter when and where such user is included in any results list generated by such vicinity query. This feature enables users to reap the benefit of receiving location-specific messages and invitations from other users who may search within the alternate vicinity specified by the user. A user might make use of this alternate location feature if, for example, he or she expects to be at a particular location at a certain time, and wishes to begin receiving location-specific messages and invitations relating to that location at some time prior to his or her arrival there.

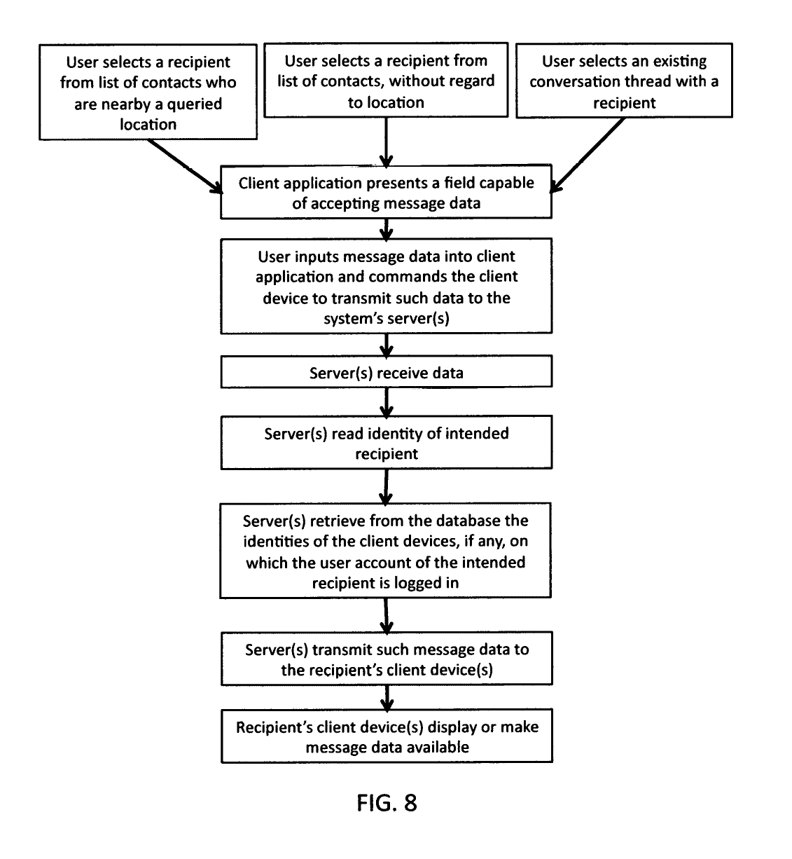

In a preferred embodiment, the client application and server(s) comprising the system permit users to communicate with each other by transmitting messages. As summarized in FIG. 8, in such embodiment, a user may select one or more recipients within the client application, input message data into the client application, and command the client device to transmit such data to the system's server(s). Upon receipt of such data, the system's server(s) process it by: reading the identities of the intended recipients, accessing the system's database of user accounts to determine which accounts are associated with the intended recipients, retrieving from the database the identities of the client devices, if any, on which the user accounts of such intended recipients are logged in, and transmitting such message data to such recipient client devices. Upon receipt of such message data, each receiving client device on which a recipient's user account is logged in displays or otherwise makes available such message data to such recipient. Additional embodiments permit users to transmit data to recipients other than, or in addition to, text. Such data may include video, audio, still images, or other digital data.

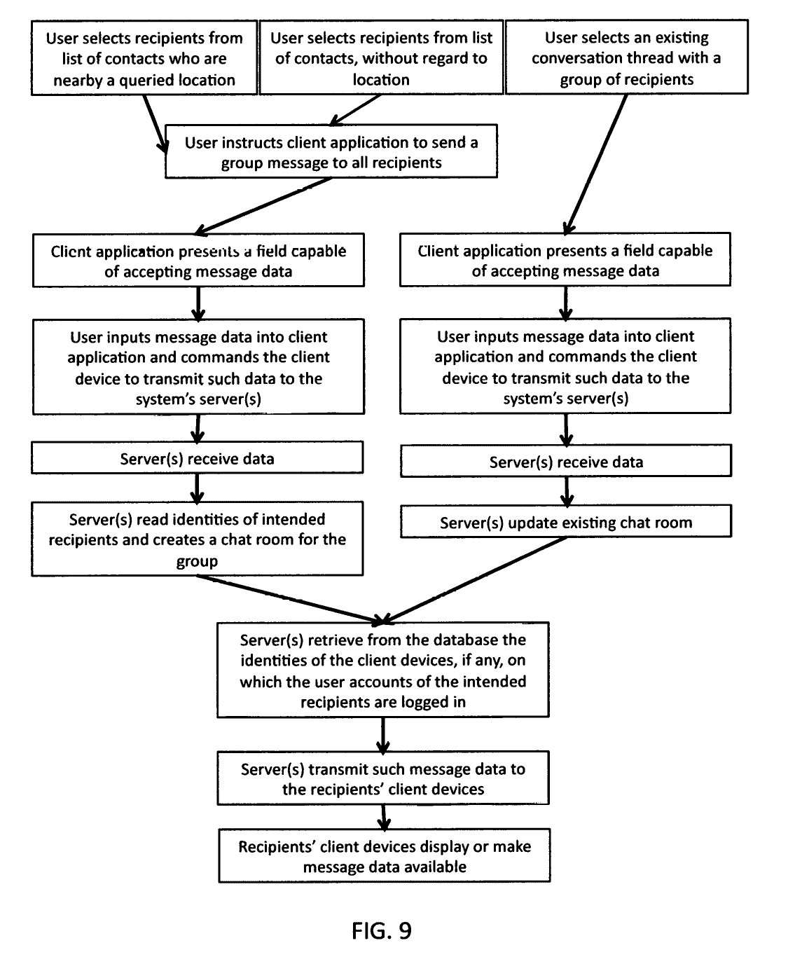

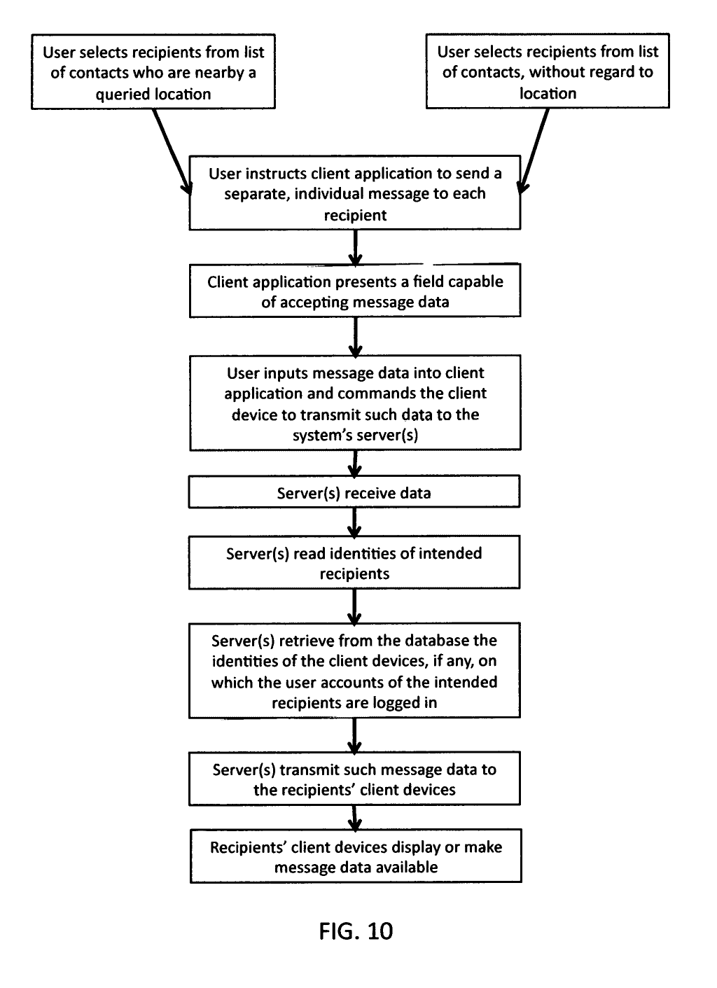

In an embodiment, the client application allows the user to select whether a message to multiple recipients should be sent: (1) as a single group message to all recipients (such that each recipient can see the identity of the other recipients) or (2) as a series of individual messages, separately to each recipient (such that each recipient is not aware that any other recipient received the same message). After receiving the selection input from the user, the data transmitted from the client application to the system's server(s) modifies the behavior of the server(s) in accordance with such selection. Specifically: if the user selects to send a group message to all recipients, as summarized in FIG. 9, the client device transmits the message data to the system's server(s), which create a group chat room for all of the recipients and which retransmit such message to the specified group of recipients; if the user selects to send a message to multiple recipients separately, as an individual message to each recipient as summarized in FIG. 10, the client device transmits the message data to the system's server(s), which retransmit such message to each specified recipient without creating a chat room for all recipients.

In a further embodiment, the application provides users with the ability to send and receive invitations to private and/or public events. Such invitations are sent from the device of the sender upon which the application is running to one or more remote servers; which servers in turn transmit such invitations to (1) in the case of private invitations, the device(s), if any, running the application on which the user accounts of the message recipients are logged in and (2) in the case of public invitations, all device(s) running the application which query such servers for public invitations associated with queried locations.

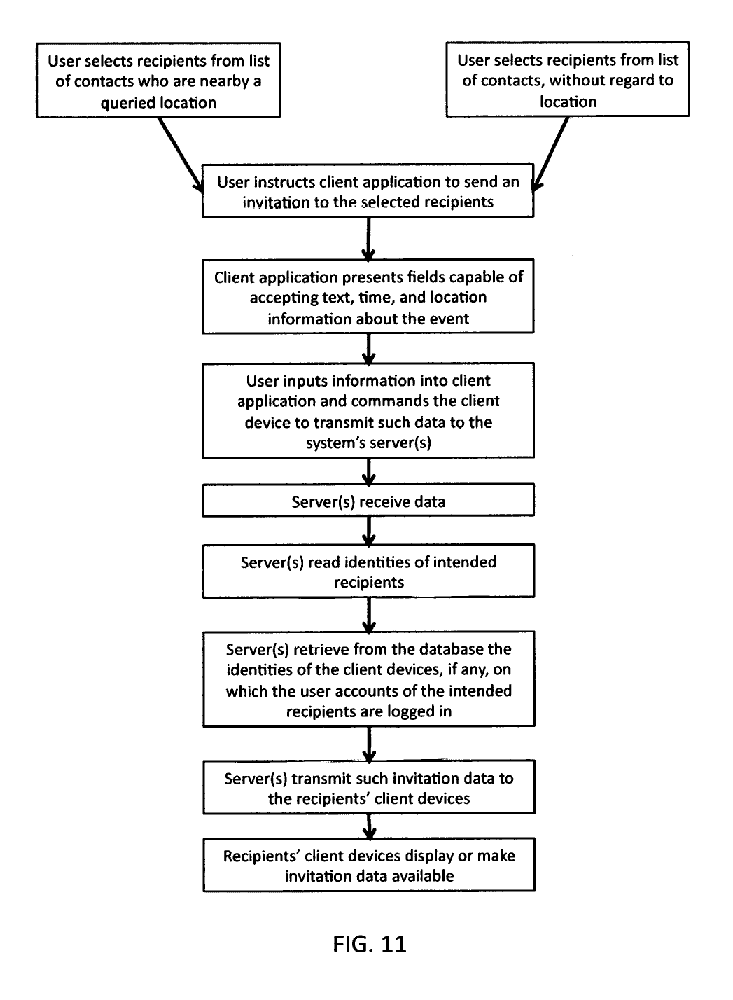

In embodiments that feature invitations to private events, the client application and server(s) comprising the system permit users to transmit invitations to events to specified invitees. As summarized in FIG. 11, in such embodiment, a user may select one or more recipients within the client application, input information about the applicable event into the client application, and command the client device to transmit such data to the system's server(s). Upon receipt of such data, the system's server(s) process it by: reading the identities of the intended recipients, accessing the system's database of user accounts to determine which accounts are associated with the intended recipients, retrieving from the database the identities of the client devices, if any, on which the user accounts of such intended recipients are logged in, and transmitting such invitation data to such recipient client devices. Upon receipt of such invitation data, each receiving client device on which a recipient's user account is logged in displays or otherwise makes available such invitation data to such recipient. Additional embodiments permit users to transmit to recipients event invitation data other than, or in addition to, text. Such data may include video, audio, still images, or other digital data.

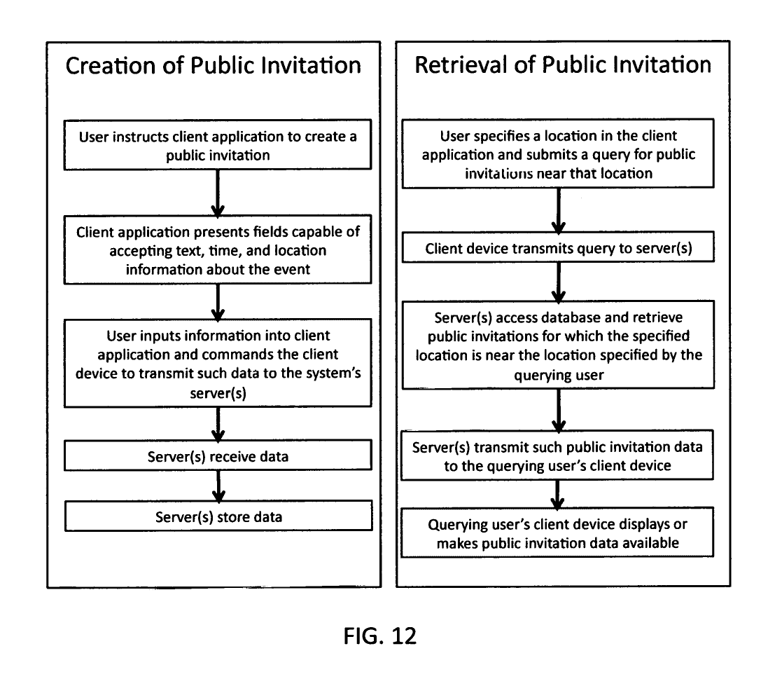

In embodiments that feature invitations to public events, the client application and server(s) comprising the system permit users to publish or distribute, to all users of the client application, invitations to events that are not restricted to specific invitees. As summarized in FIG. 12, in such embodiments, a user may input information about the applicable event into the client application, specify within the client application that the invitation is to be made available to the public, and command the client device to transmit such data to the system's server(s). Upon receipt of such data, the system's server(s) process it by storing such data in the system's database. Other users of the client application can command the application to query the system's database for public events, including events relating to geographic locations specified by such users. As summarized in FIG. 12, upon receipt of such a query, the system's server(s) access the system's database, search the database for public events satisfying the querying user's search criteria, and transmit to the querying user's client device data about any public events satisfying such user's search criteria. Upon receipt of such public event data, the receiving client device displays or otherwise makes available such public event data to such querying user. For example, in an embodiment, invitations to public events are viewable by all users of the system by visual review or search of either: (1) a mapping interface within the application (upon which public events are marked by visual elements overlaid on the map location of the applicable event) or (2) a listing of invitations to public events that the application makes available to users. Additional embodiments permit users publishing public invitations to include data other than, or in addition to, text. Such data may include video, audio, still images, or other digital data.

In a further embodiment, the system also routes communications through other protocols (including, for example, SMS and email) so that users of the application can send information (such as messages or invitations) to non-users from within the application. Further embodiments can provide users of the application with the ability to communicate through non-text-based means, such as audio and/or video transmission or the transmission of still images or other digital files.

In certain embodiments, if a user grants appropriate permissions to the client application running on the user's device, the client application populates the list of other users to whom the user should be denoted as connected within the system by a variety of methods. For example, in an embodiment, the system determines which users of the client application should be denoted in the system's database as being connected to a given user without requiring such user to send connection requests to, or take individual actions with respect to, other users. In such embodiment, if a user grants appropriate permissions to the application running on the user's device, the client application accesses the list of contacts stored on, or made available through, such client device and transmits the telephone numbers and email addresses of such contacts to the system's server(s). Upon receipt of such data, the system's server(s) access the system's database to search for user accounts associated with any of such telephone numbers and email addresses. If the database includes a user account associated with any such phone number or email address, the server(s) query the database to determine whether the user whose account is associated with such phone number or email address has or had the transmitting user's telephone number or email address stored on, or made available through, his or her client device. The server(s) modify the database to denote as connected any two users who have each others' telephone numbers and/or email addresses stored in, or made available through, their respective client devices. In a preferred embodiment, the client application transmits to the server(s), and/or the server(s) store in the database, a hash of any such contact information. Accordingly, in such an embodiment, the matching procedure described above takes place with respect to a hash of any such contact information rather than the contact information itself.

In another embodiment, the client application accesses the user's list of Facebook friends and transmits such information to one or more of the system's servers. Upon receipt of such data, the system's server(s) access the system's database to search for user accounts associated with any of such Facebook friend. If the database includes a user account associated with any such Facebook friend, the server(s) modify the database to denote as connected any two users who are each others' Facebook friends. In a preferred embodiment, the client application transmits to the server(s), and/or the server(s) store in the database, a hash of any such Facebook information. Accordingly, in such an embodiment, the matching procedure described above takes place with respect to a hash of any such Facebook information rather than the Facebook information itself.

Additional embodiments may make use of additional mechanisms for determining which users of the application should be denoted in the system's database as being connected to each other and, if so, denoting such connections in the system's database. Such additional mechanisms may include, without limitation, (1) examination of the connection lists of other social media platforms or (2) an invitation-request model wherein a user sends requests from his or her client application, through the system's server(s), to other users of the client application, seeking permission to be connected to those other users, and a connection is denoted in the system's database with respect to a request-sender and a request-recipient if such request-recipient accepts such request.

In an embodiment, those other users of the system who are denoted in the system's database as being connected to a given user are listed on a “friend list” for such user, which list is displayed to the user within the interface of the application. In additional embodiments, a user may create one or more subcategories or sublists of such other users.

In some embodiments, the application also displays a user's contacts (such as those drawn from his or her device's list of contacts) who are not themselves users of the system (or are not denoted within the system's database as being connected to such user), allowing such user to make use of the application's features that allow users to communicate through protocols (such as SMS or email) other than the application's internal messaging client or invitation system.

In one such embodiment, the client application running on the sender's client device may access the contact information stored on, or made available through, such device and may permit the sender to select recipients for whom he or she has contact information but who are not themselves users of the client application. In such a case, the system comprised of the client application and the server(s) transmits the sender's message, invitation, or other data over one or more of such other protocols according to an order of priority, which may be predefined by the system or may be defined by the sending user. For example, if a user composes a message or invitation and selects a group of recipients that include: (1) other users of the client application, (2) individuals who do not use the client application but for whom the sender has a telephone number, and (3) individuals who do not use the client application but for whom the sender has an email address, the system in such embodiment will: (1) transmit the message or invitation to the client application running on the client device(s), if any, on which the user accounts of recipients who use the client application are logged in, (2) route the message or invitation to the SMS application of the sender's device, or send the message or invitation via SMS, for those recipients who do not use the client application but for whom the sender has a telephone number, and (3) route the message or invitation to the email application of the sender's device, or send the message or invitation via email, for those recipients who do not use the client application but for whom the sender has an email address.

In an embodiment, if a sender specifies a recipient who does not have a client application account but for whom the sender has both a telephone number and an email address, the system will send the message or invitation via SMS instead of email. In additional embodiments, the system may feature additional external protocols for transmitting information and/or may feature a different order of priorities for the use of such external protocols. In further additional embodiments, the client application may permit a sender to specify his or her preferred order of priorities for the use of such external protocols. In further additional embodiments, the client application includes input fields into which a sender may input contact information for a recipient, such as a telephone number or an email address, such that the sender may use the client application to send messages or invitations to recipients who may not be users of the client application and for whom contact information may not be stored on, or otherwise made available through, the sender's client device.

In further embodiments, additional communication protocols can be added to, or removed from, the collection of external communication protocols utilized by the system to provide users with further ways to communicate with others (regardless of whether those others use the system). In such cases, the order in which such protocols are applied may be altered by the system or defined by the user.

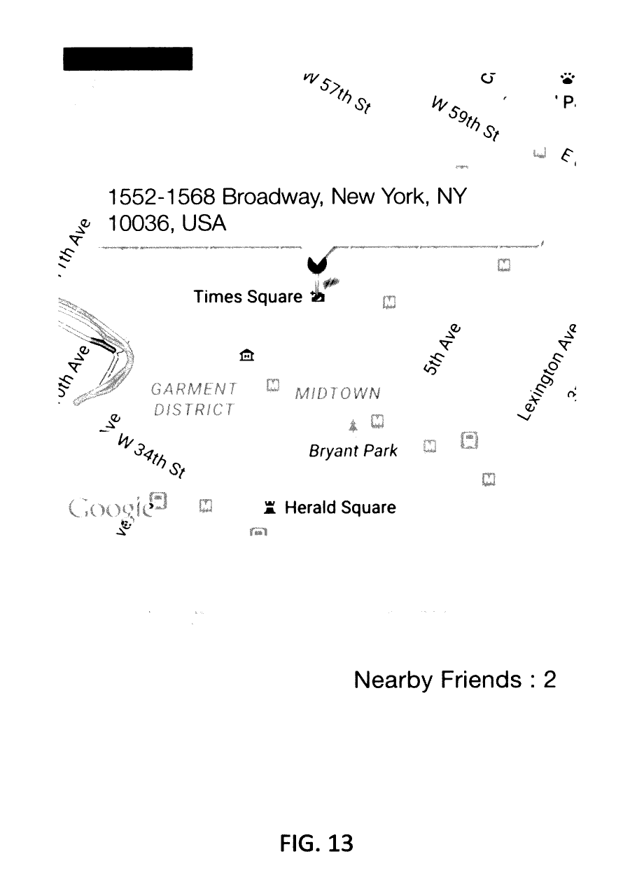

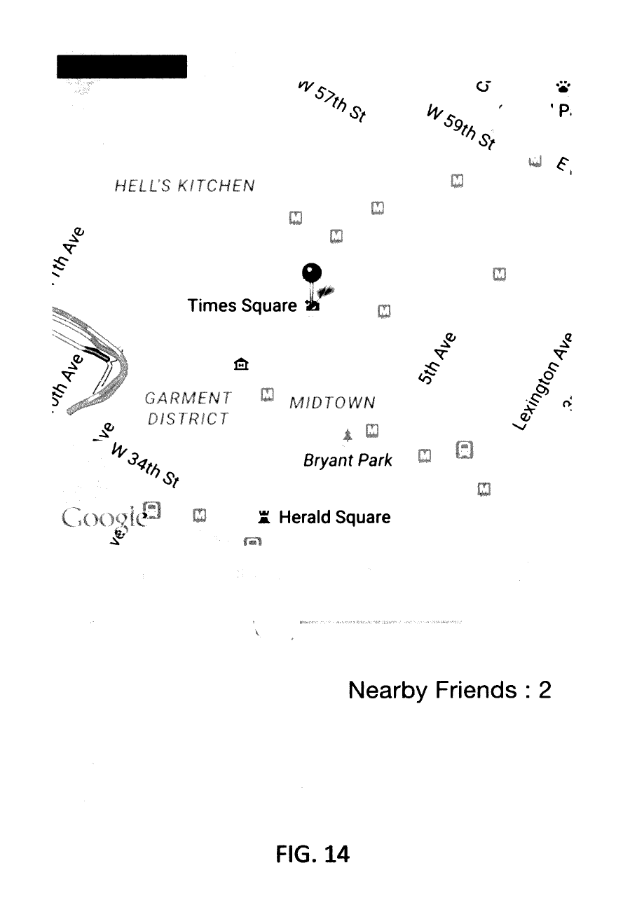

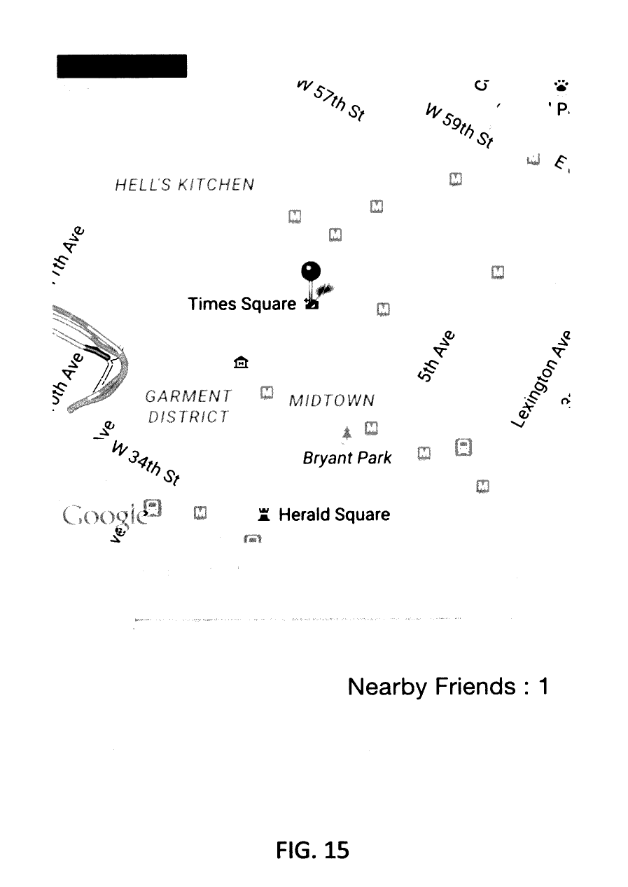

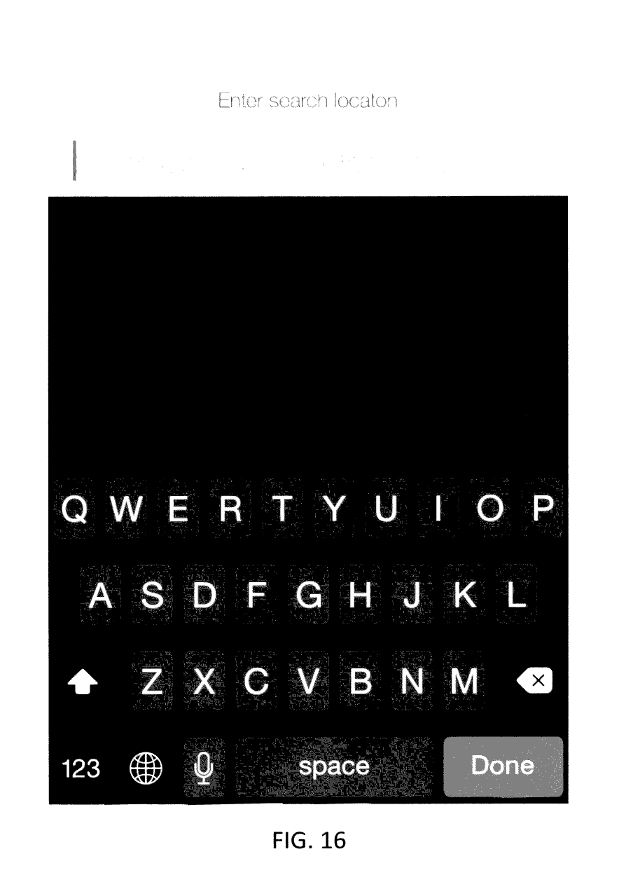

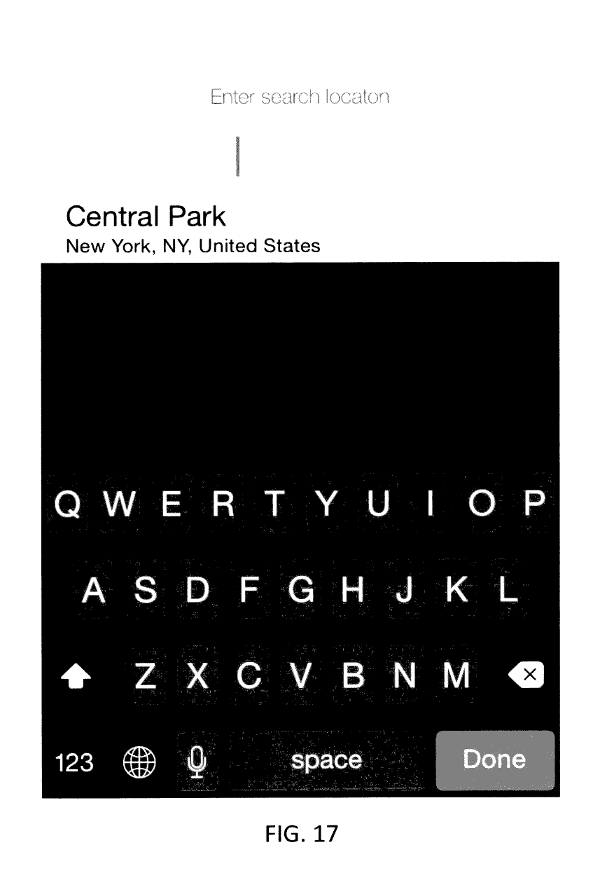

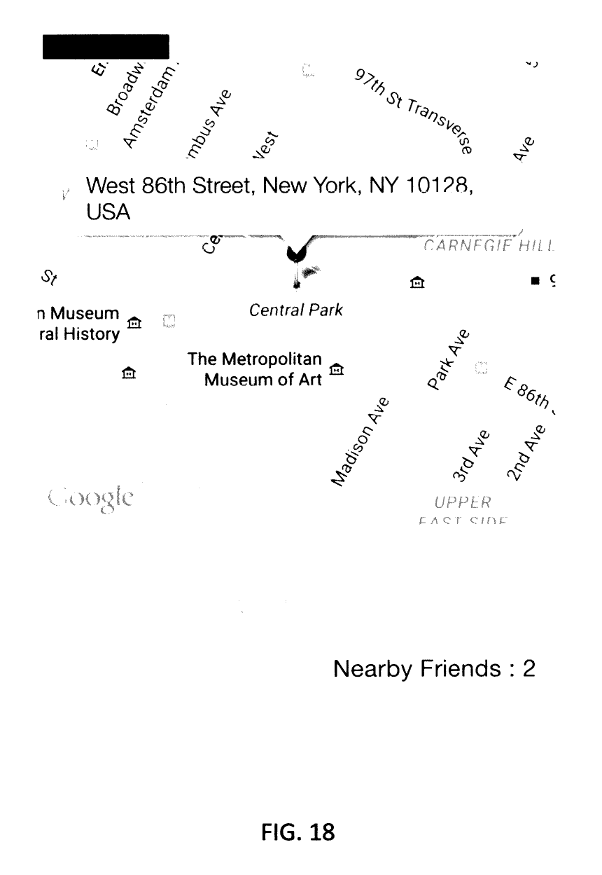

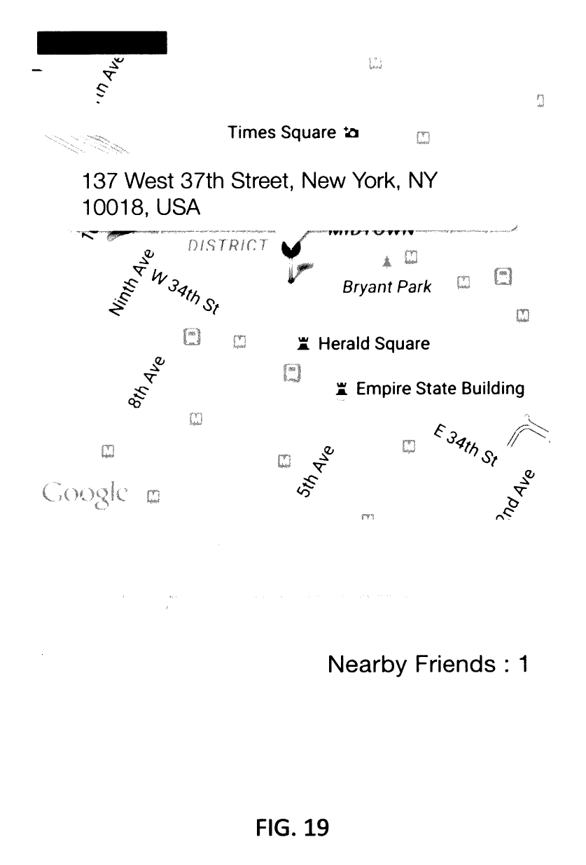

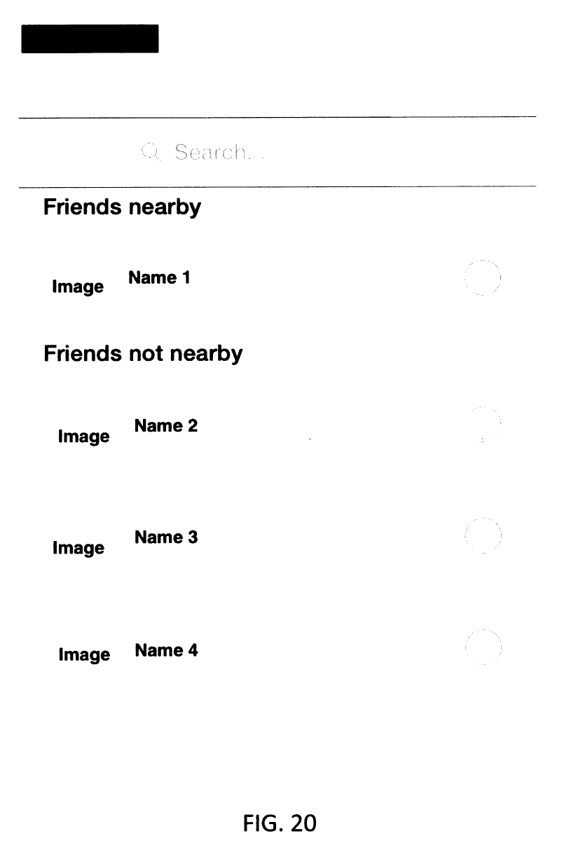

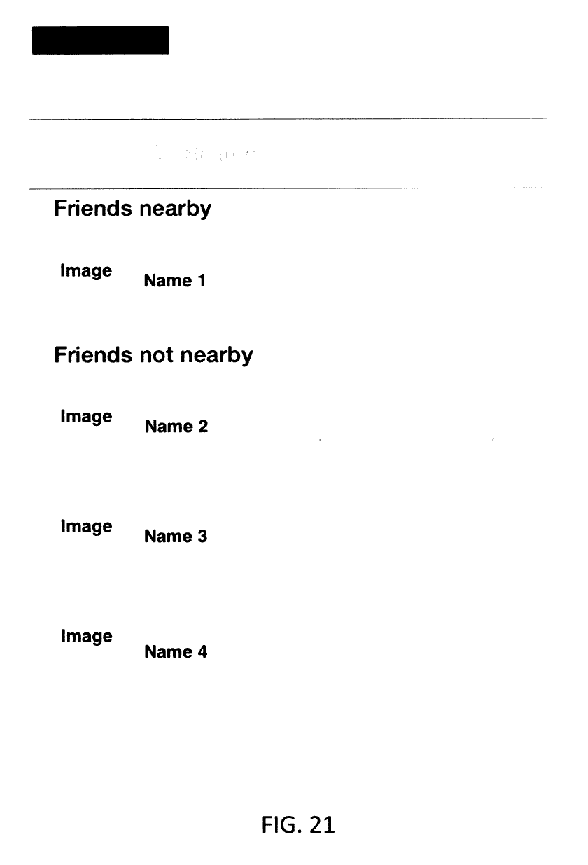

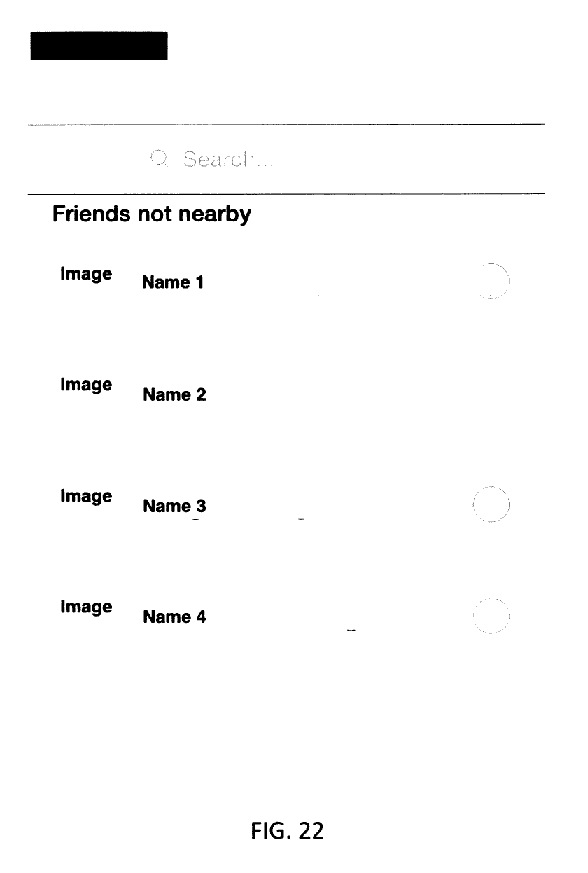

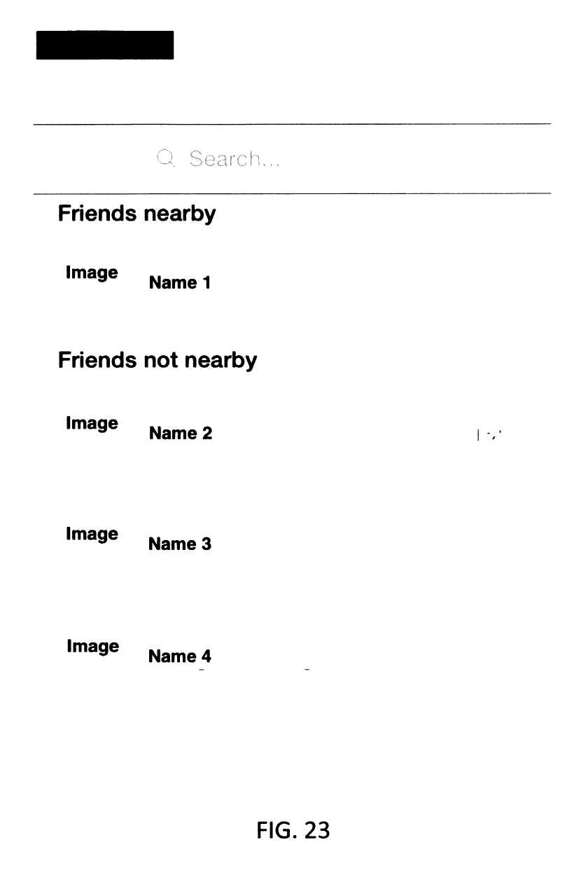

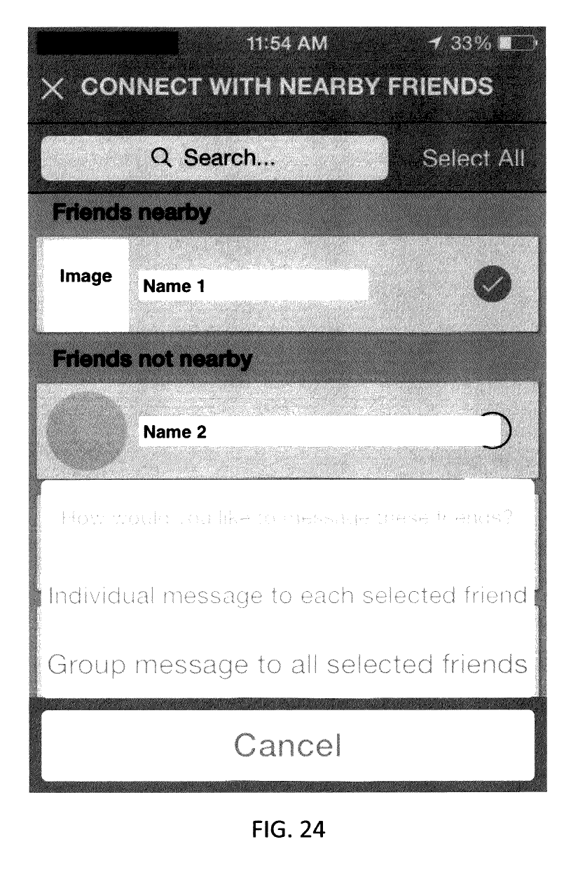

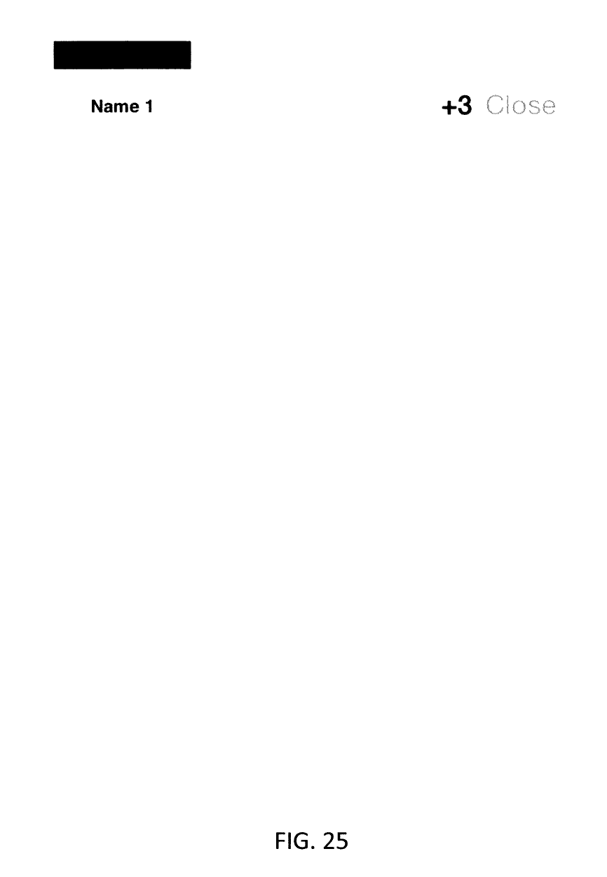

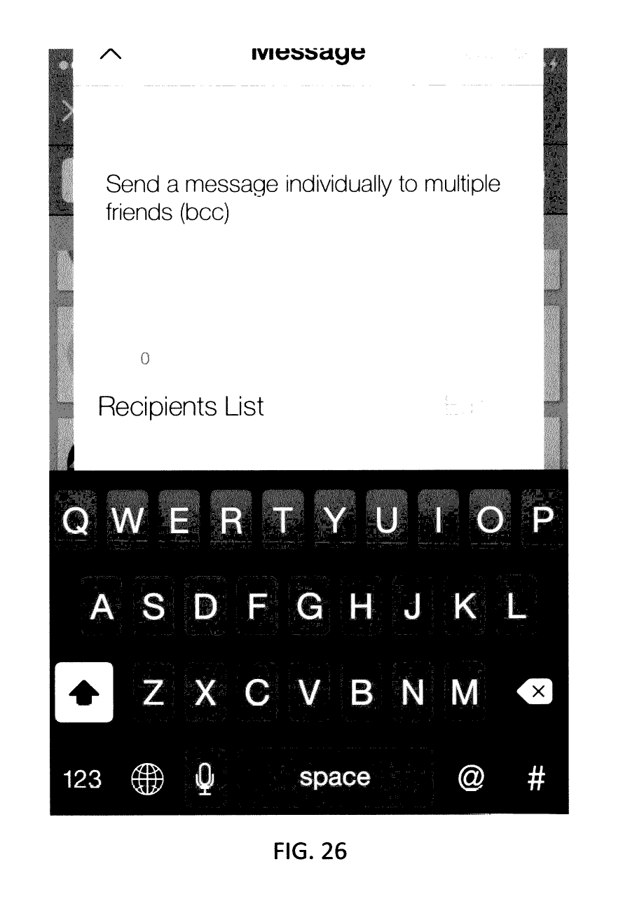

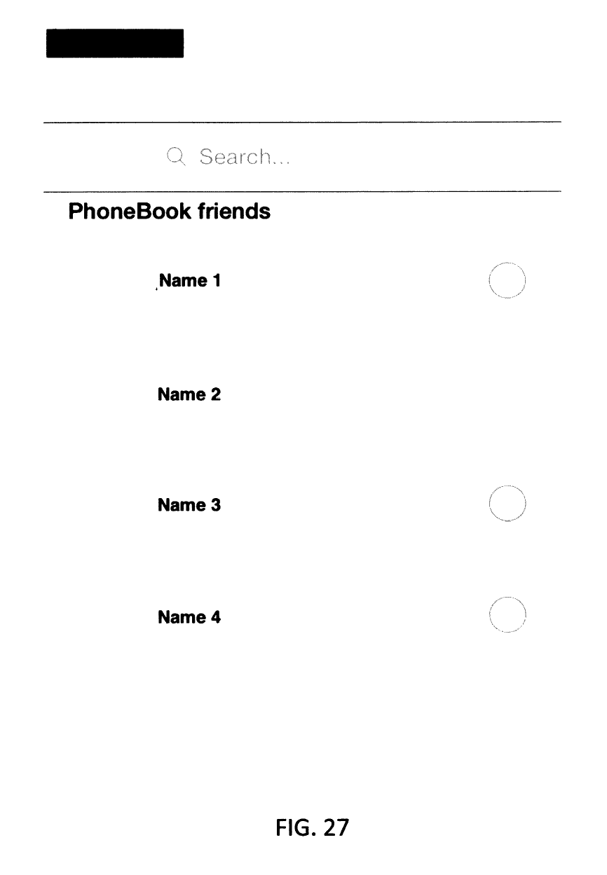

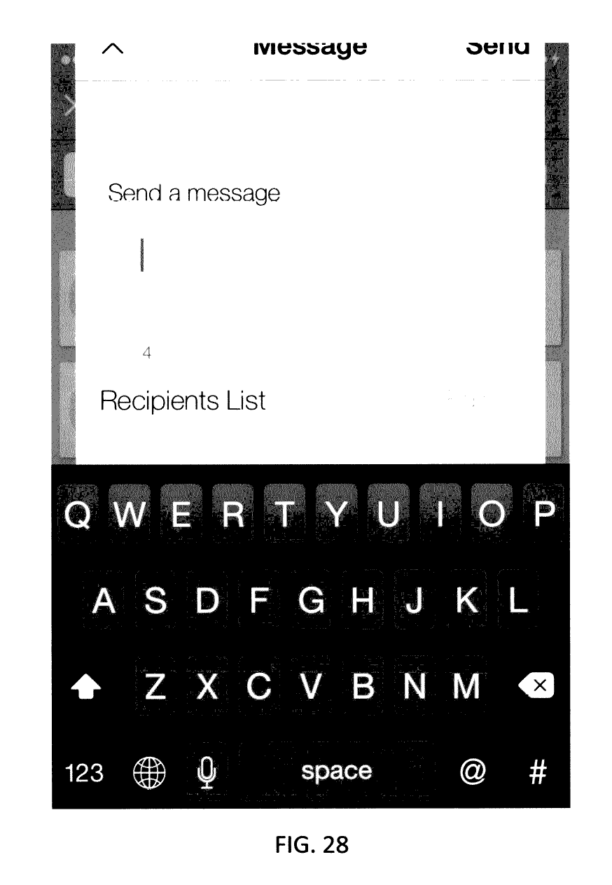

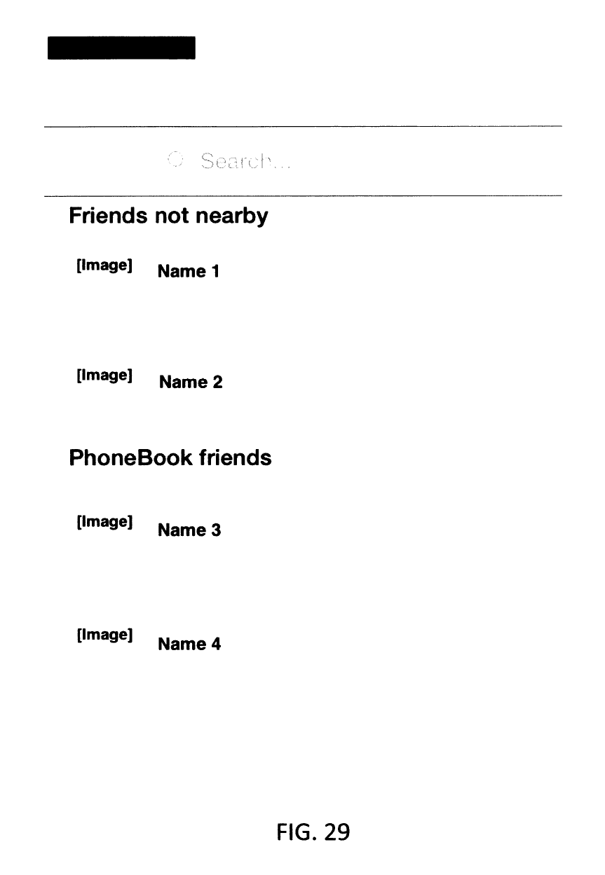

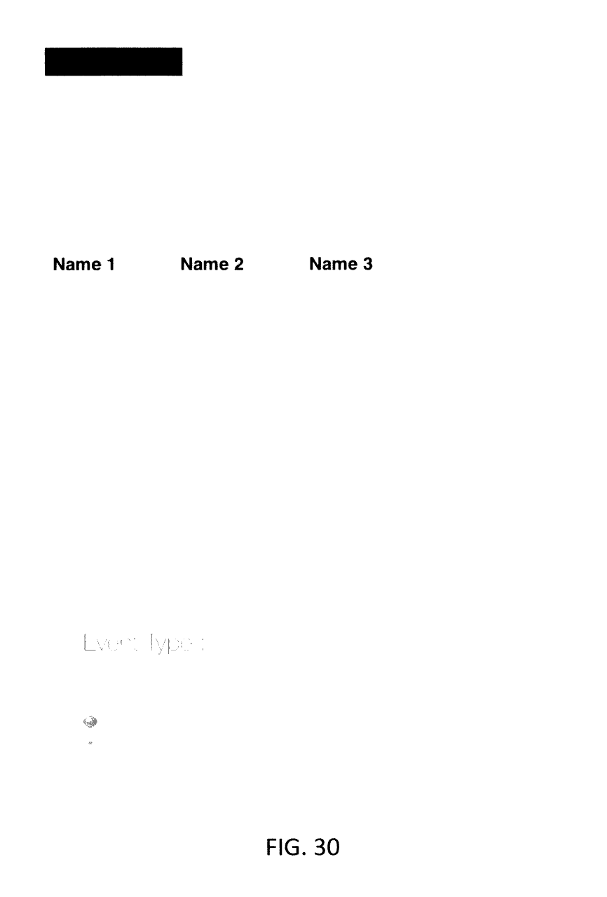

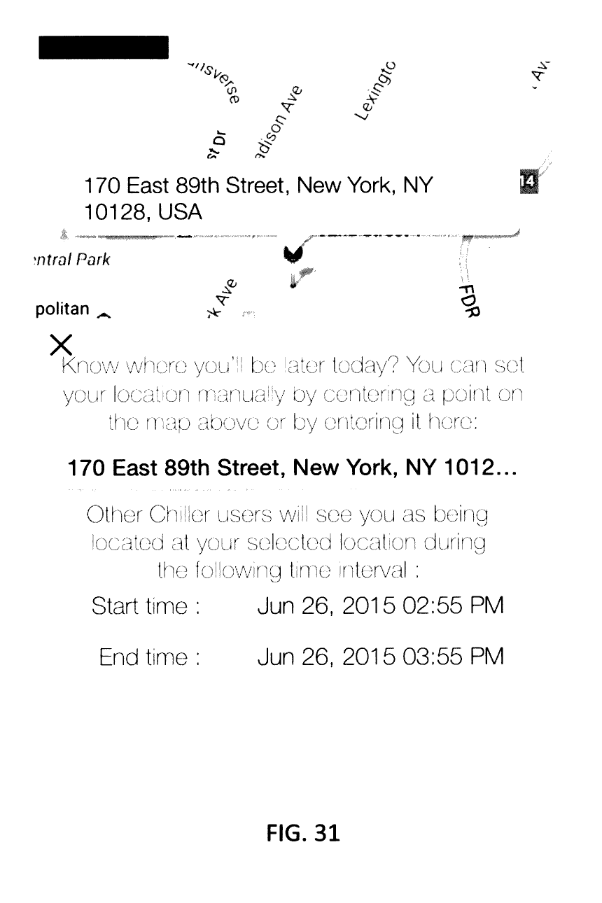

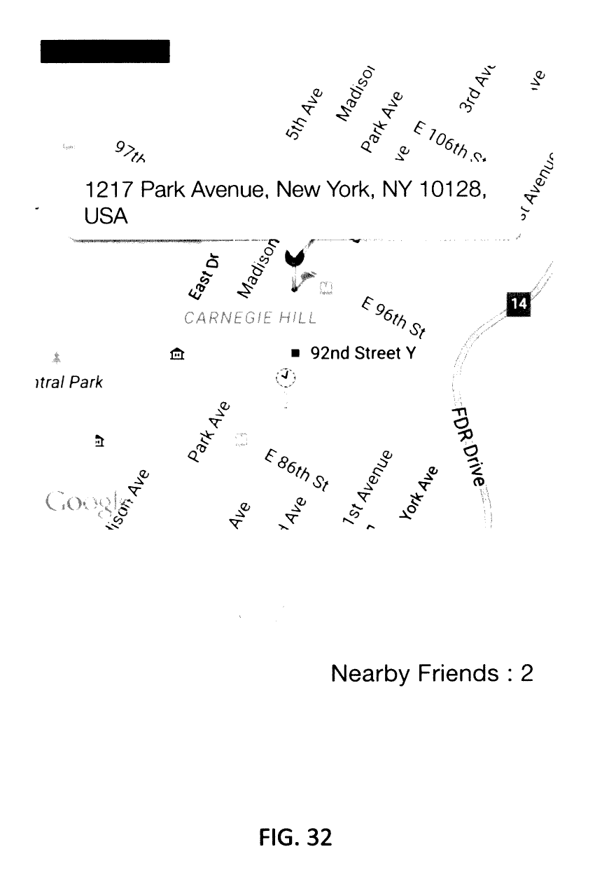

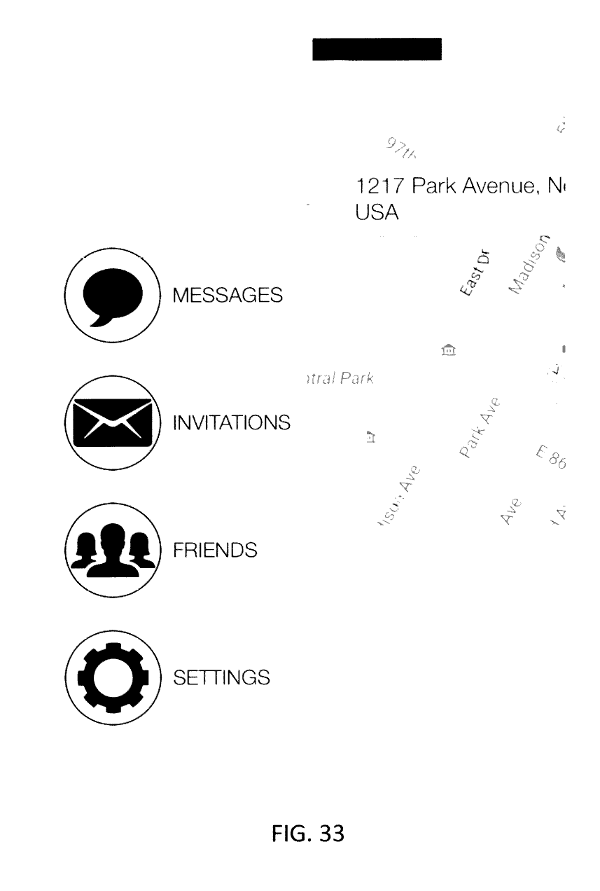

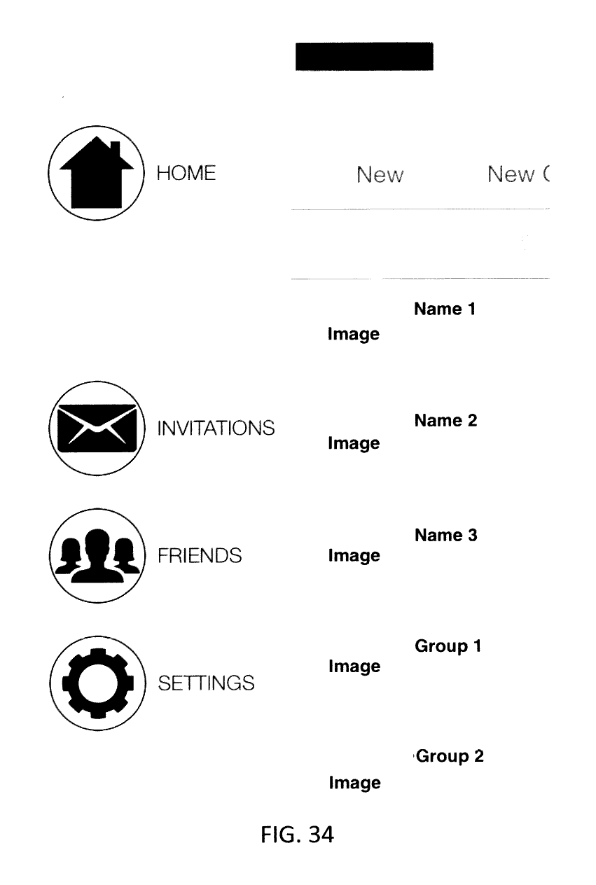

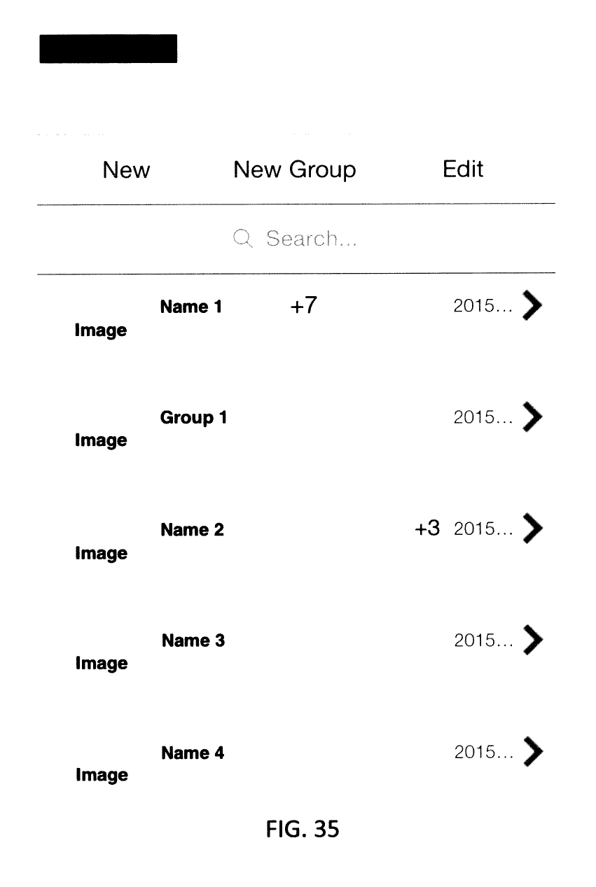

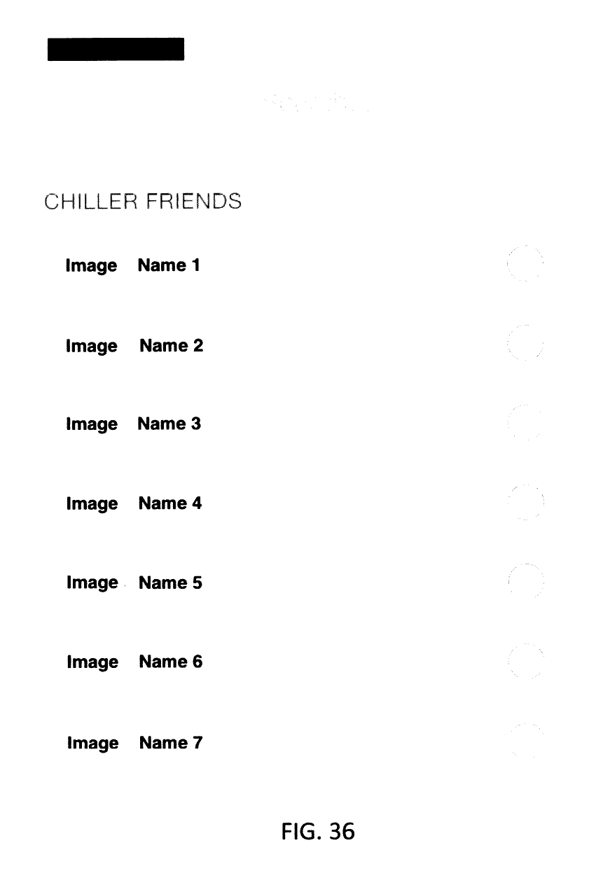

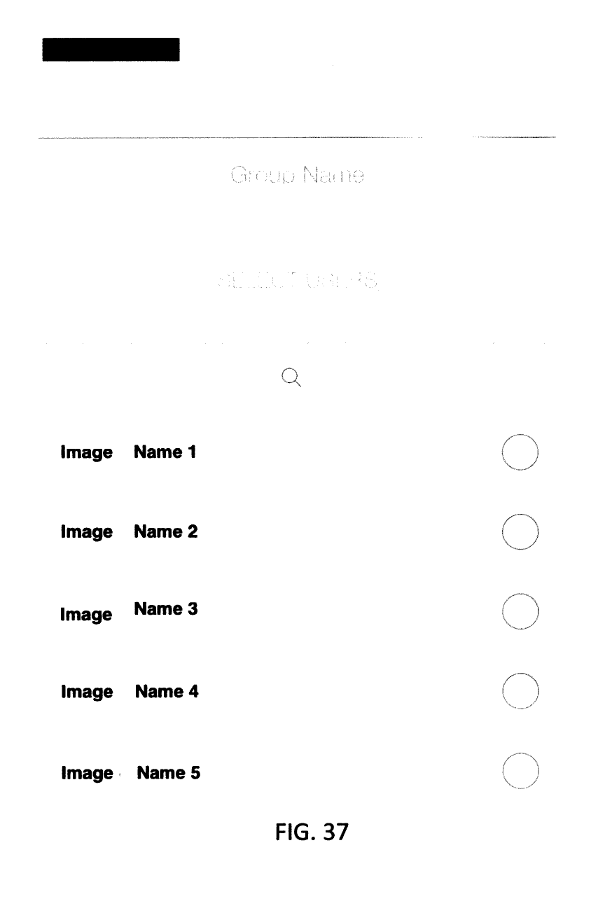

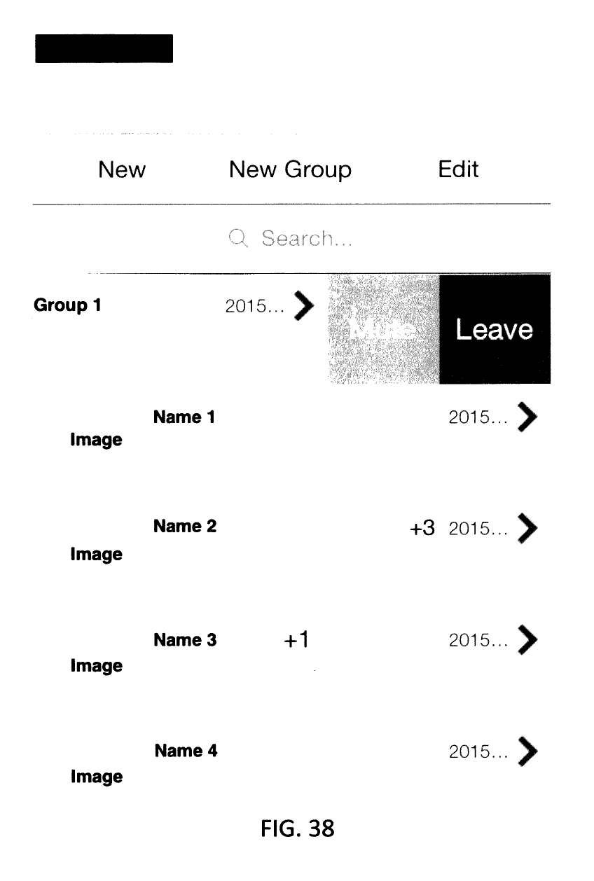

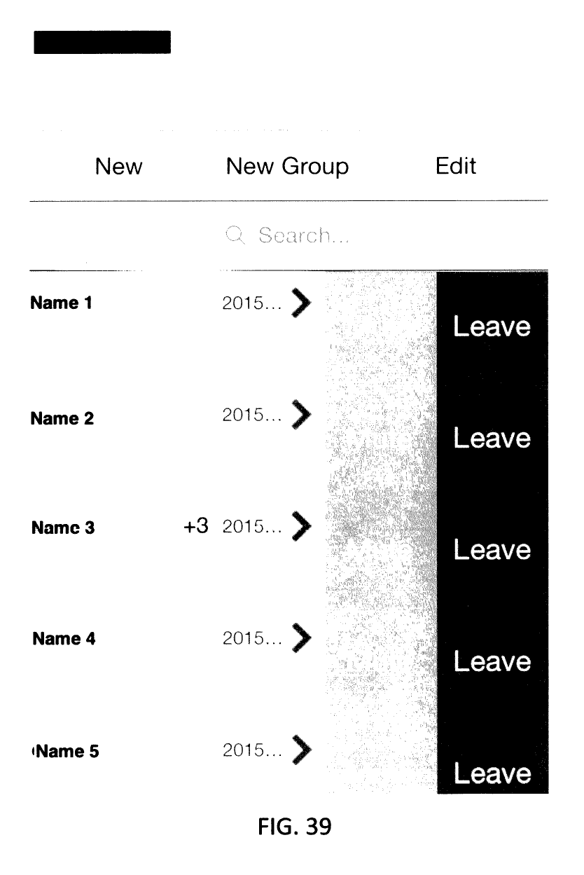

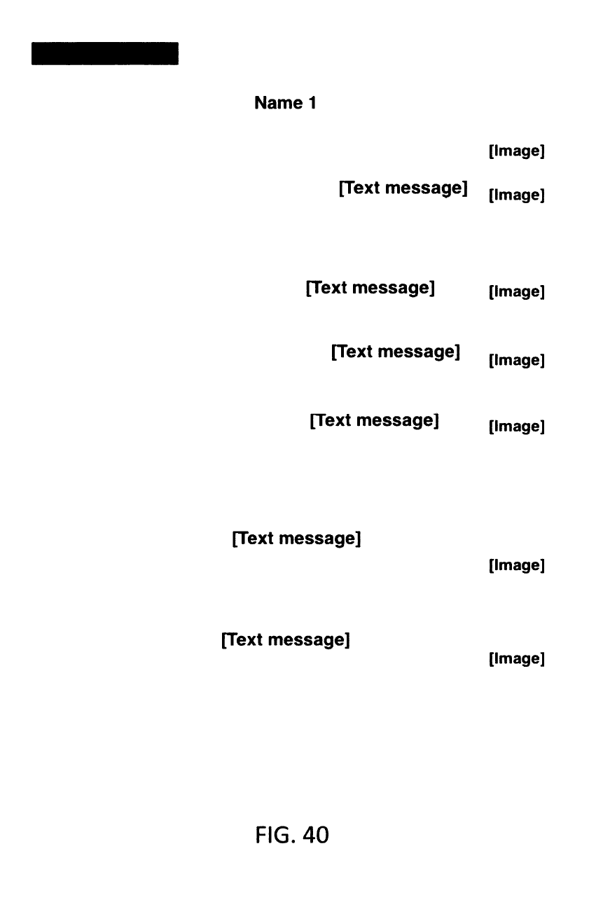

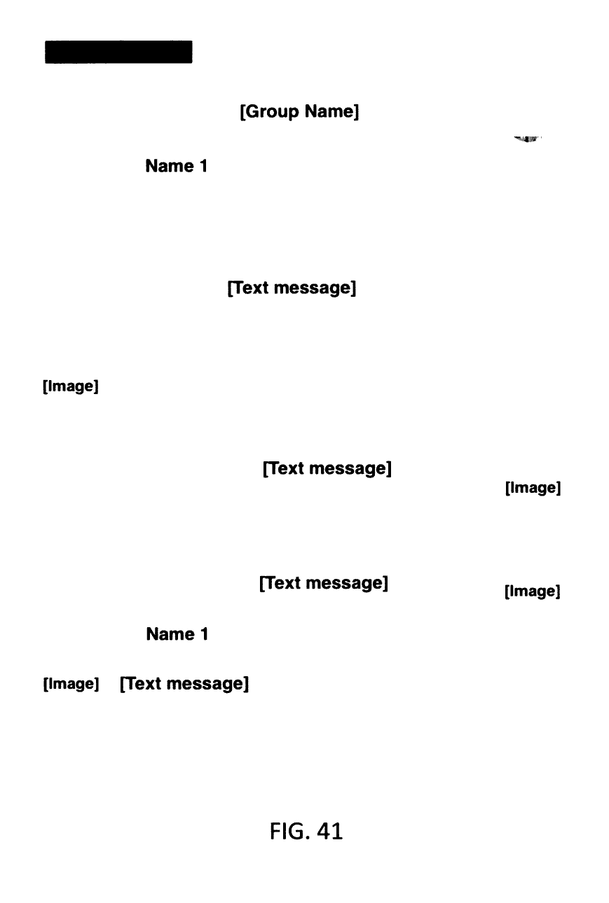

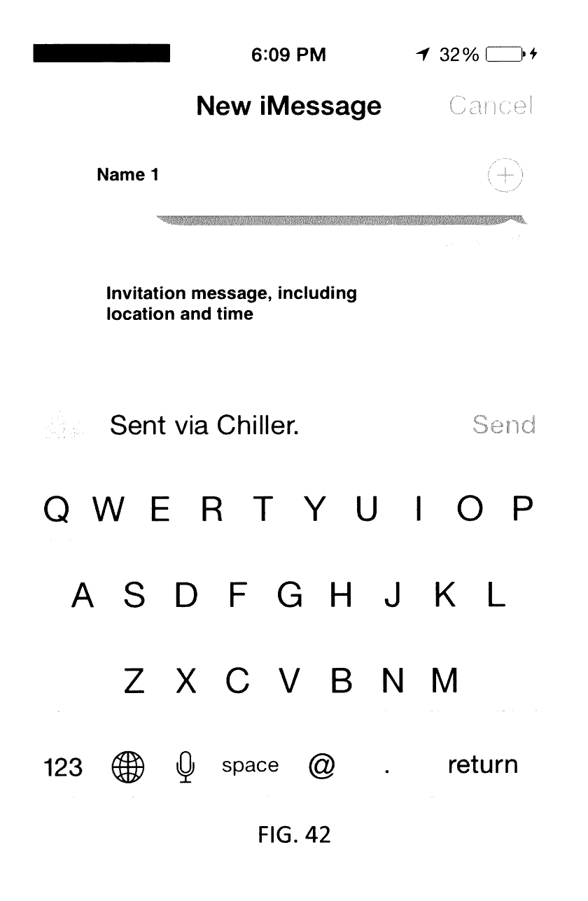

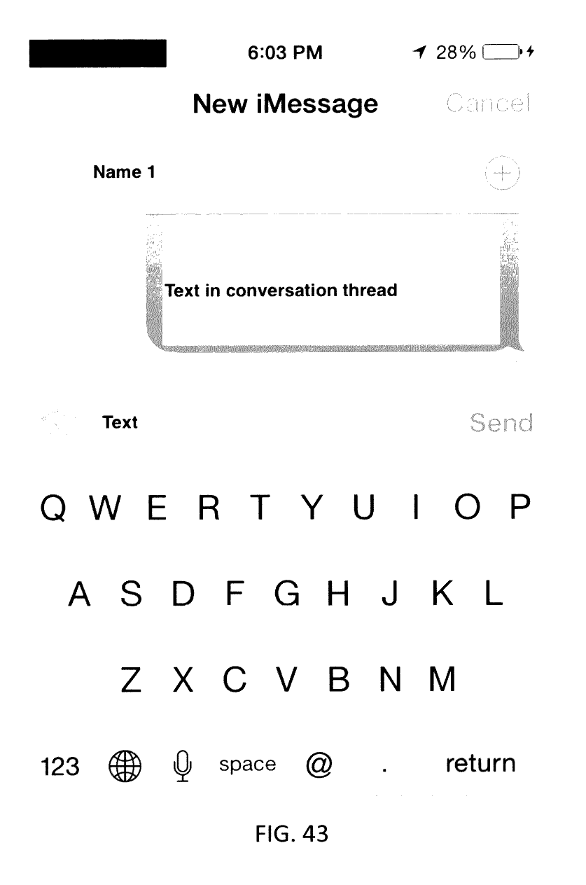

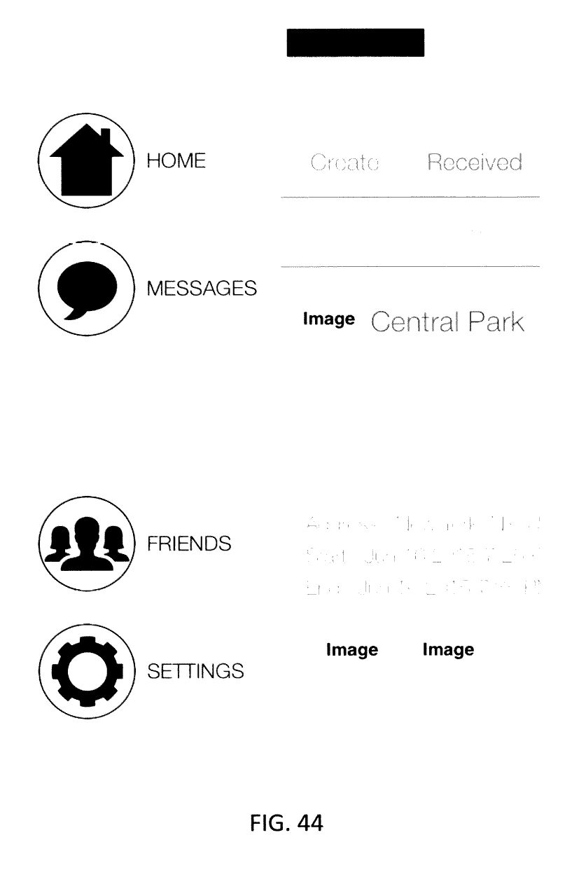

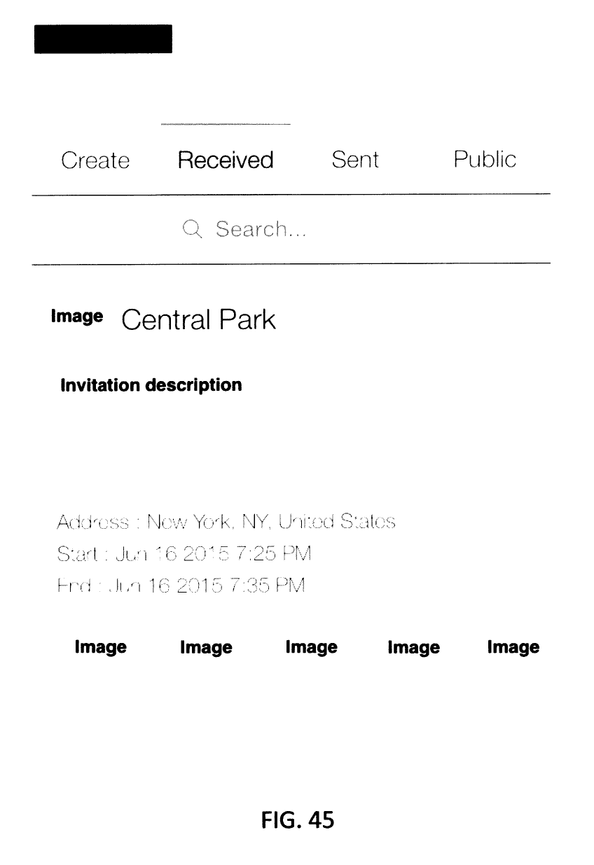

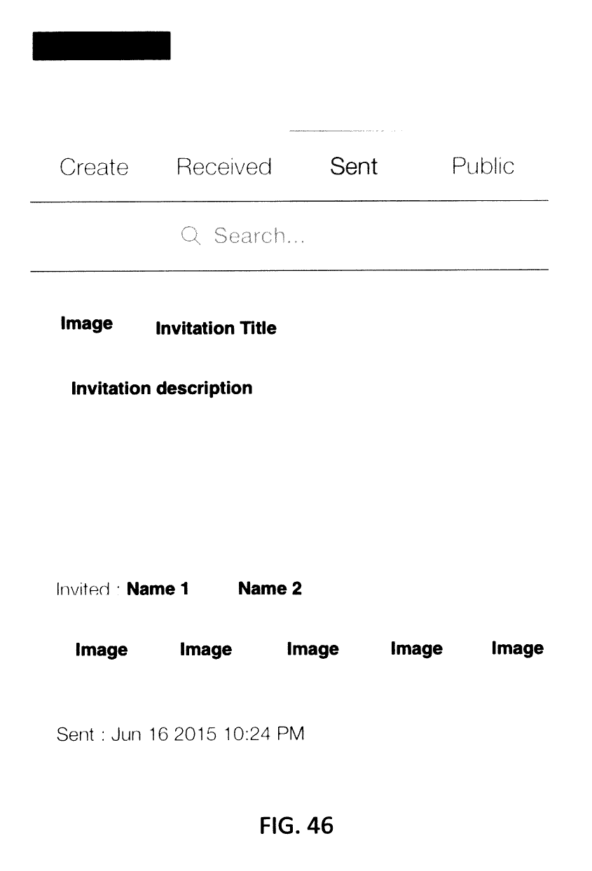

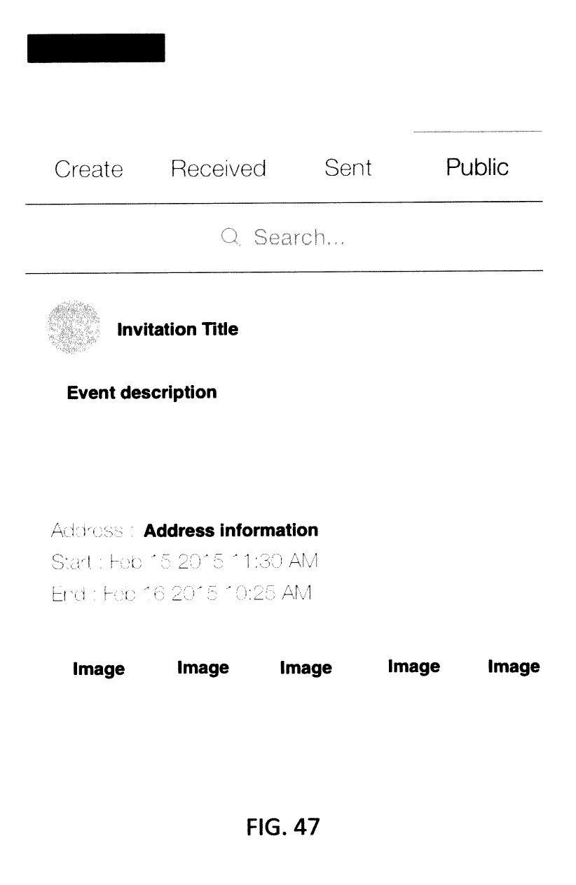

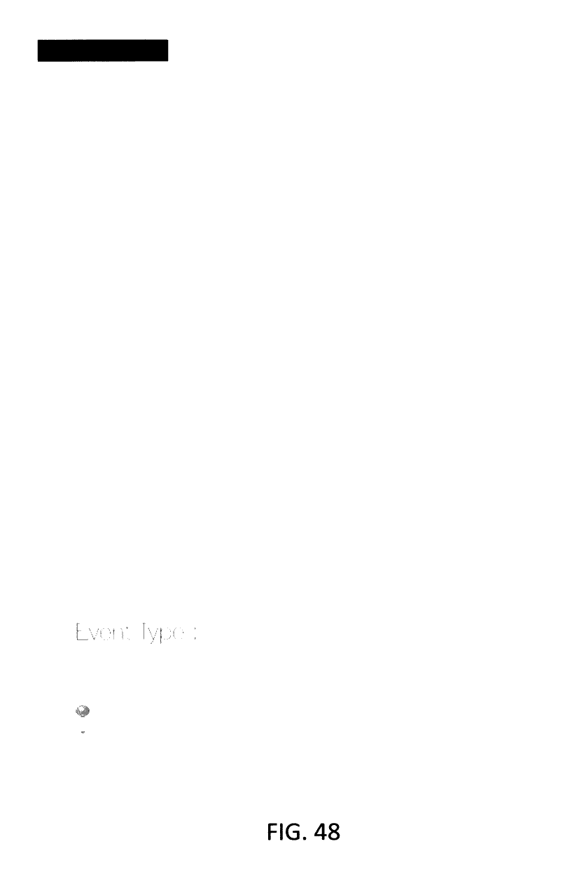

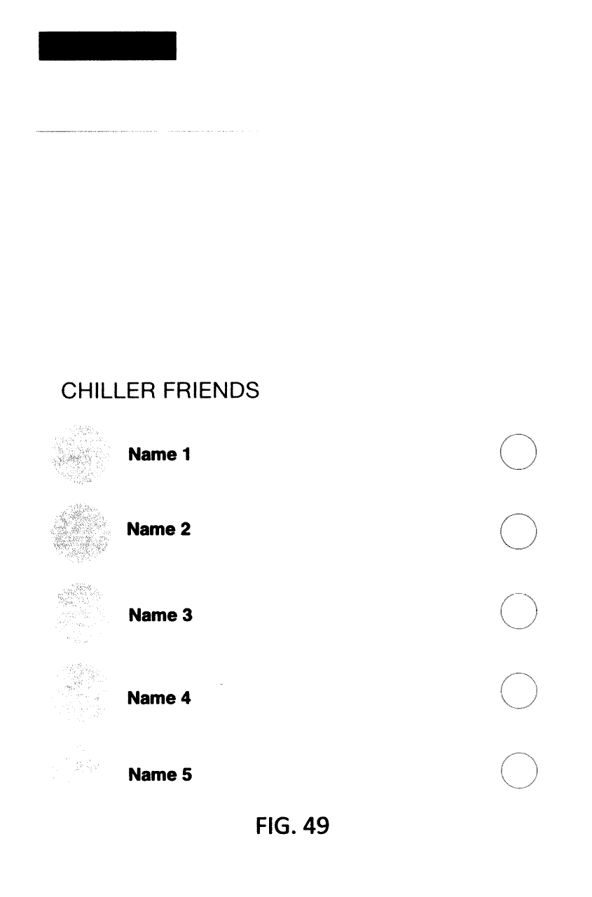

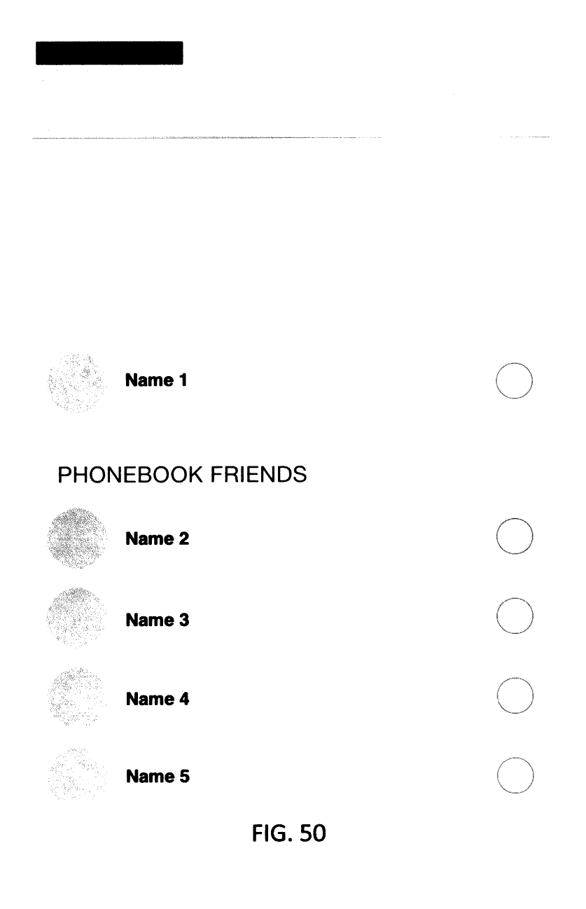

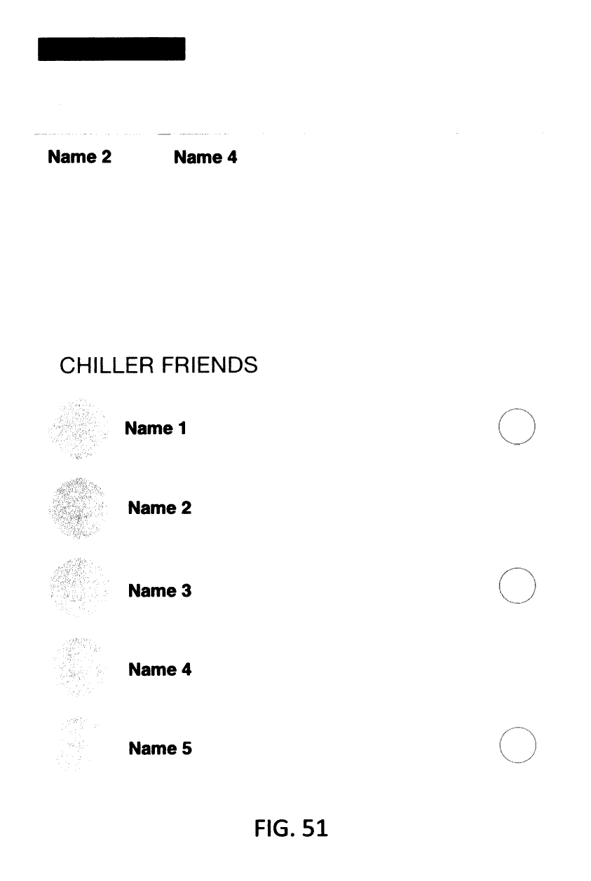

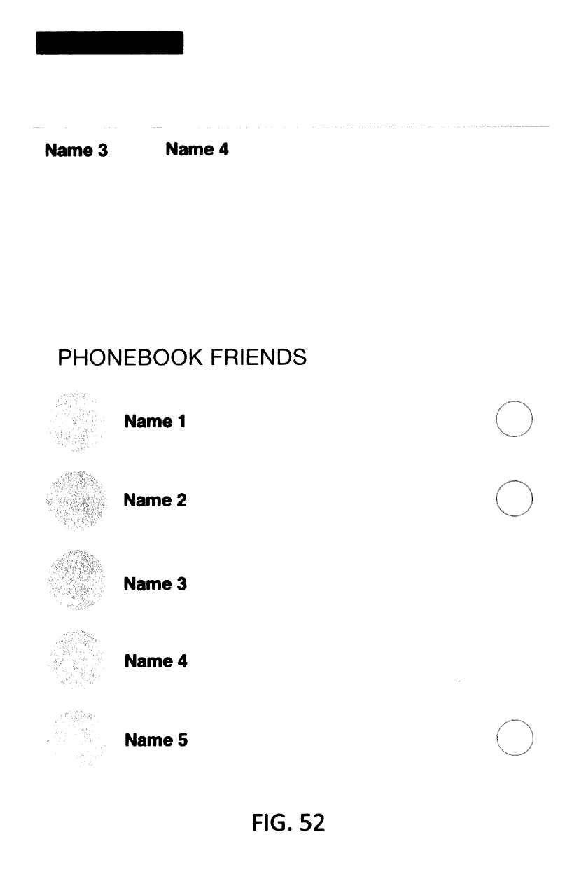

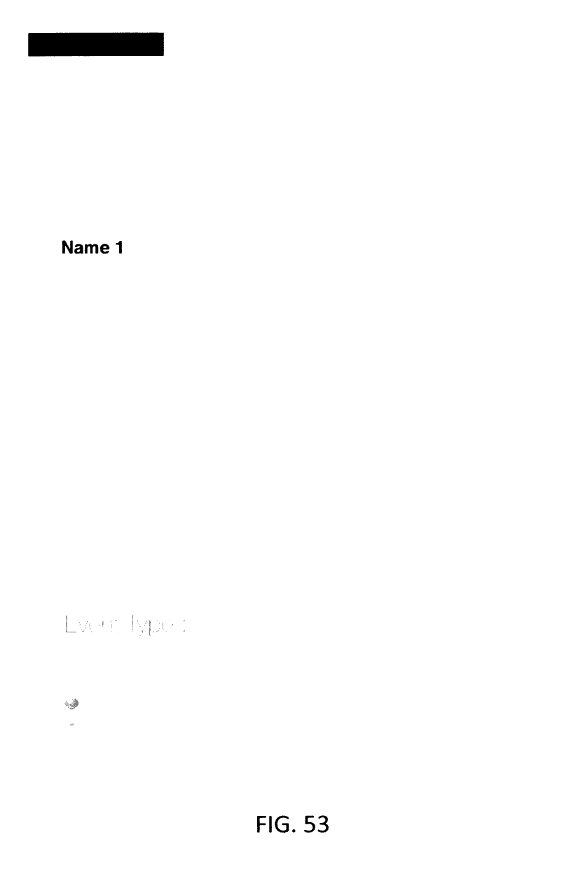

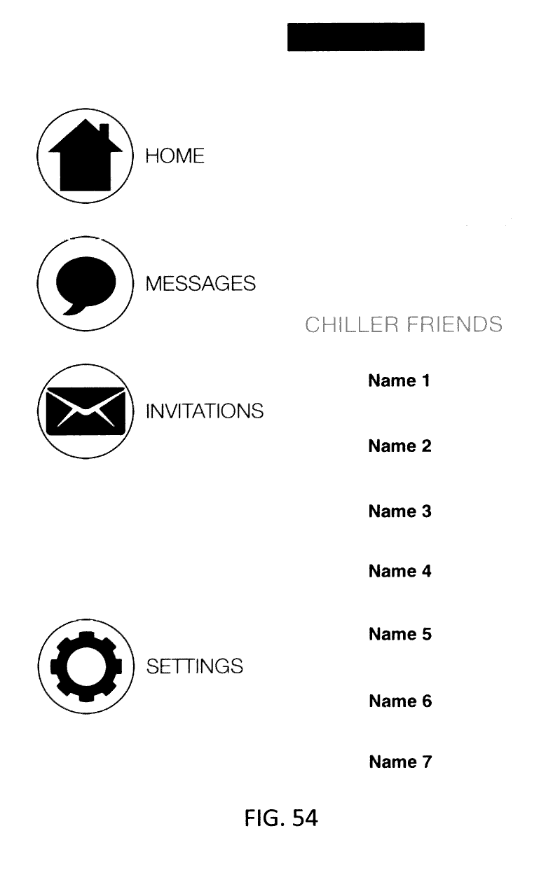

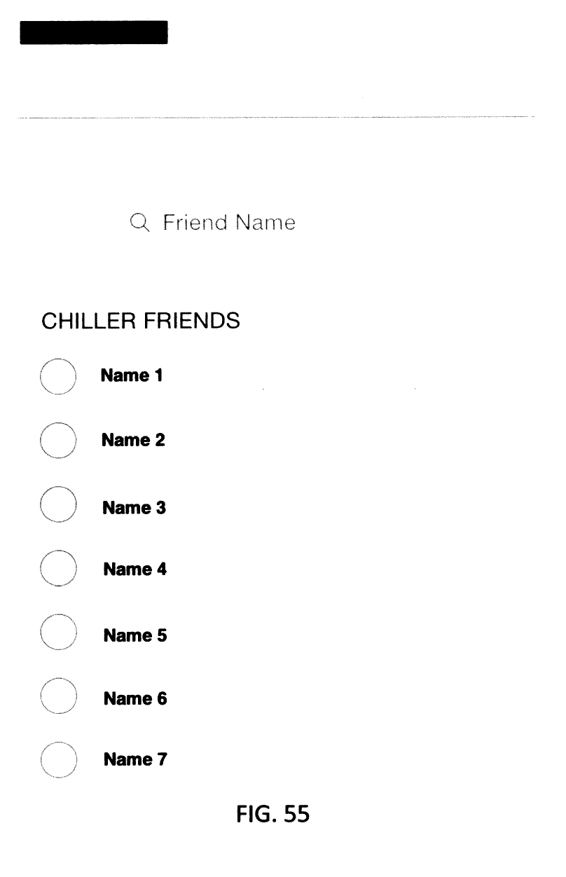

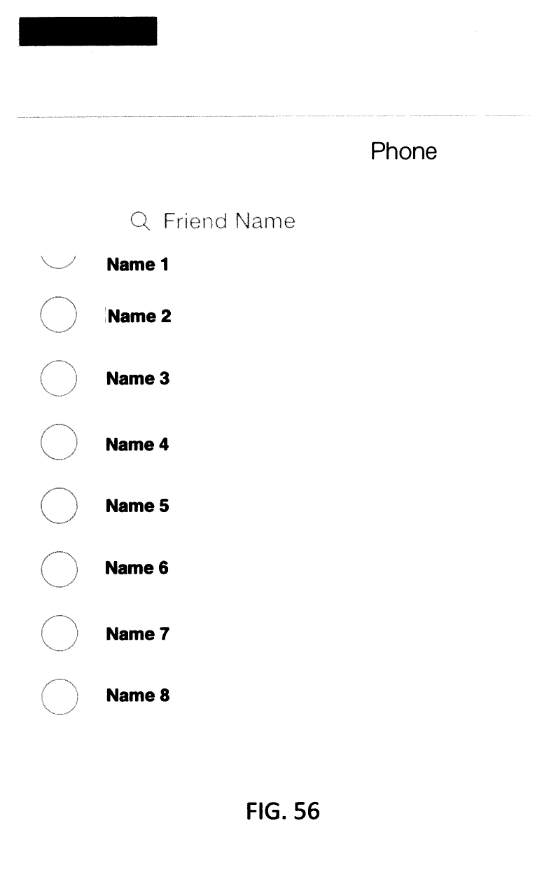

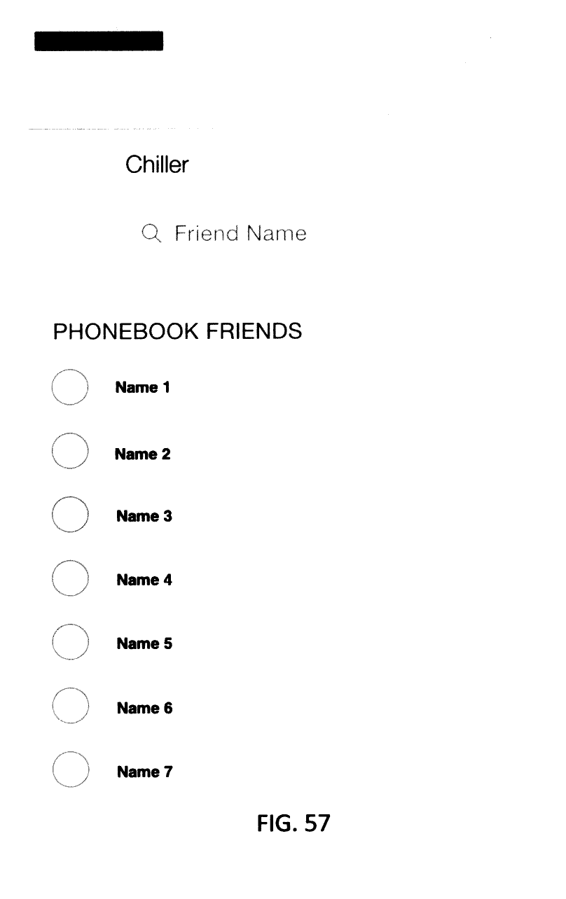

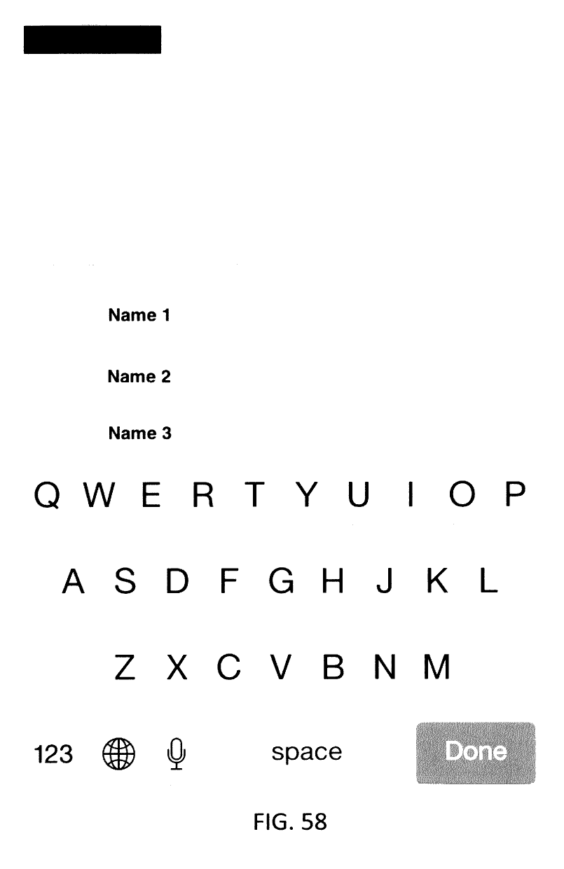

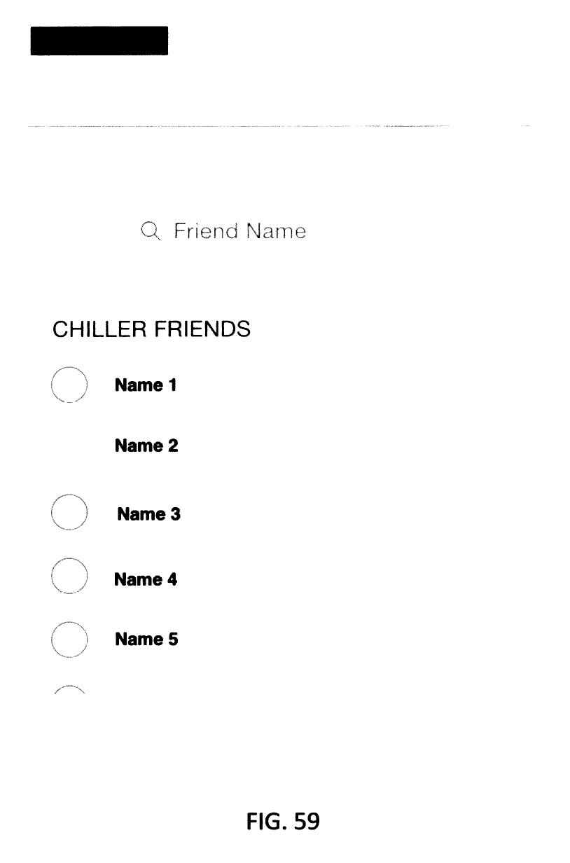

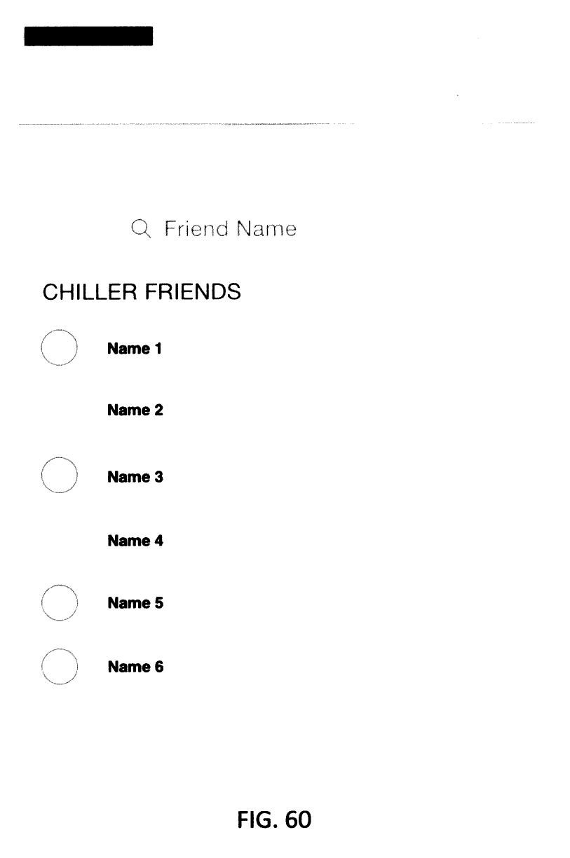

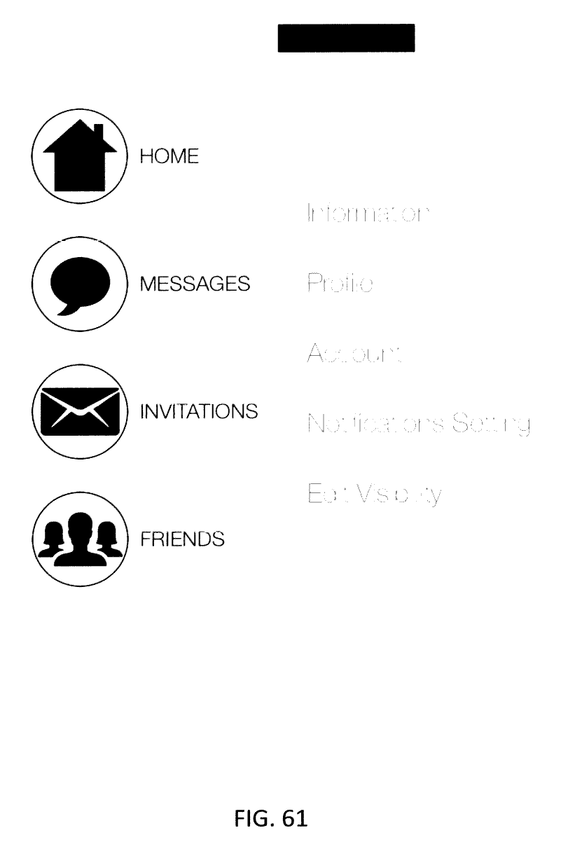

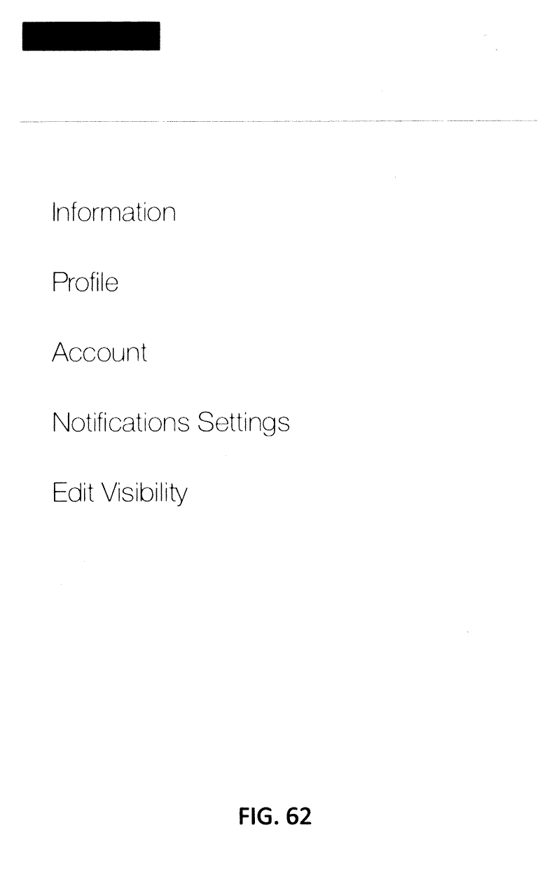

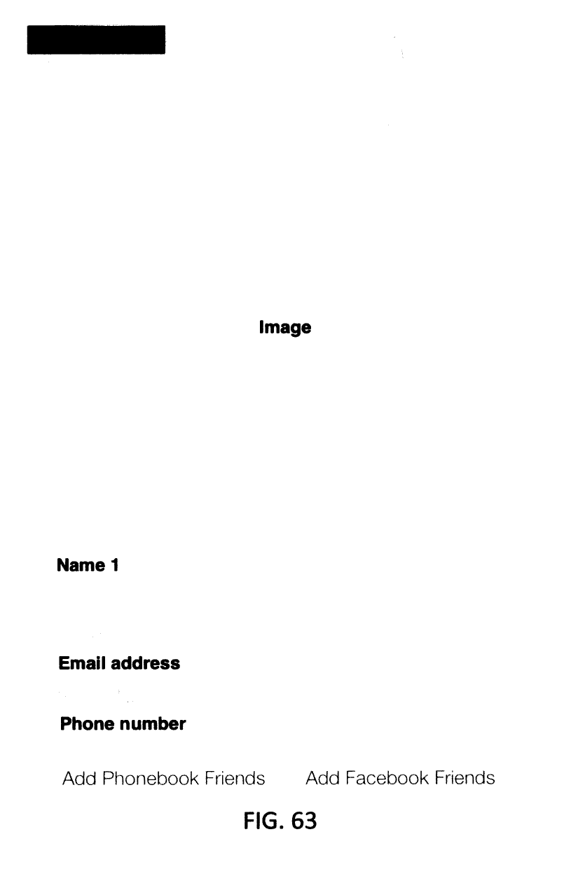

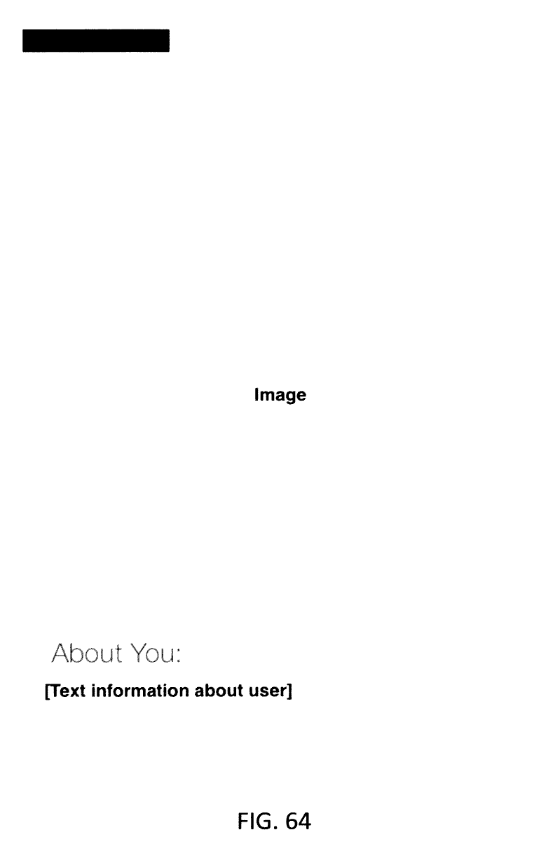

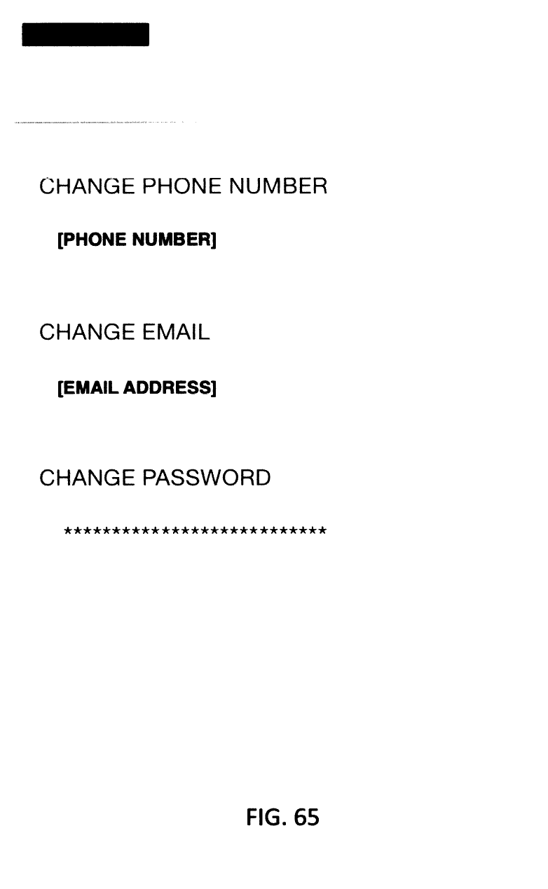

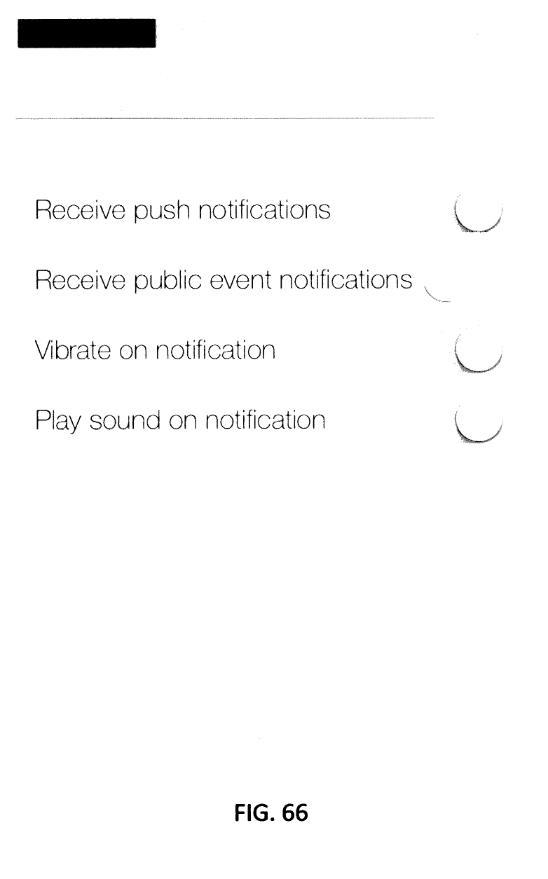

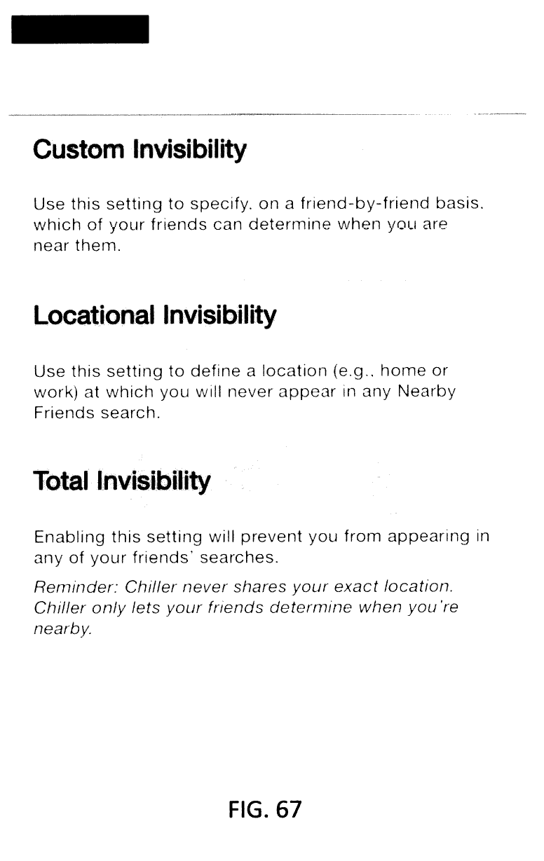

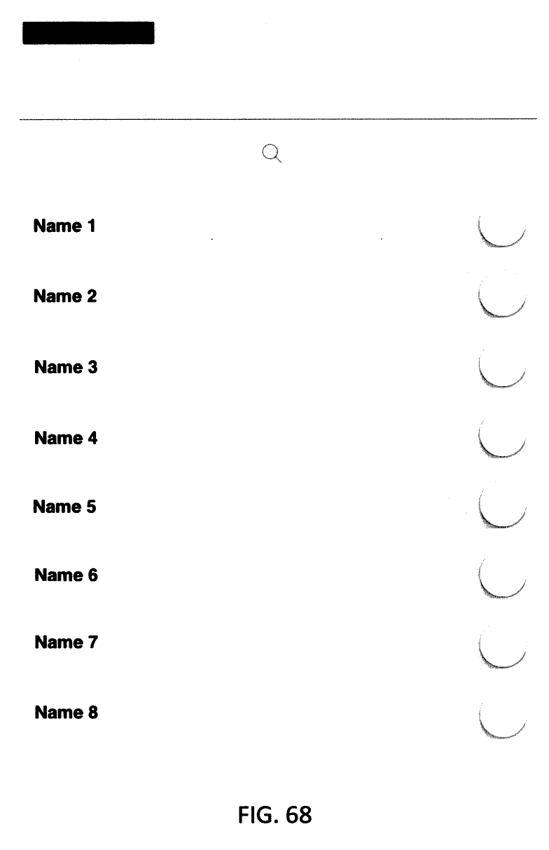

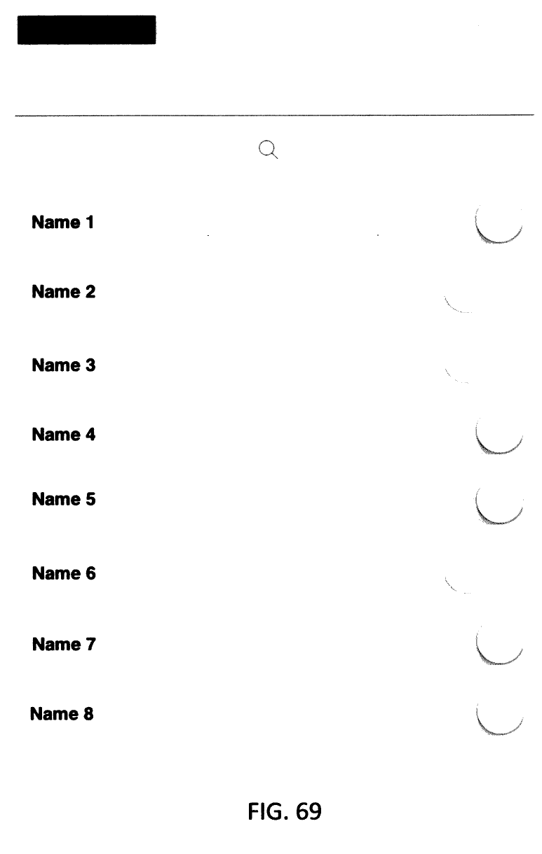

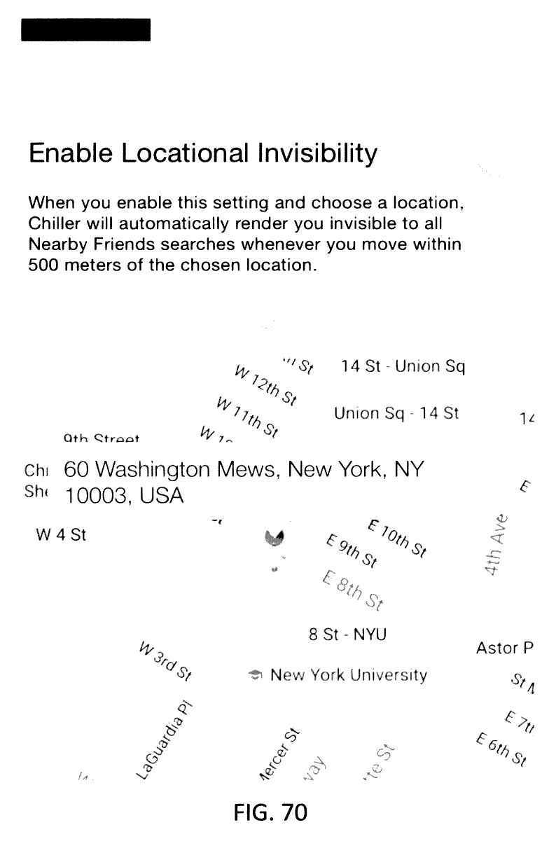

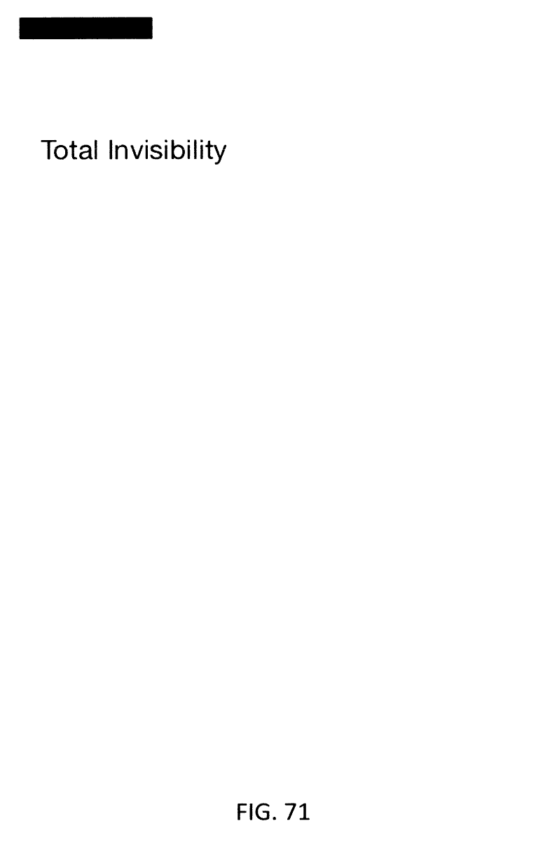

FIGS. 13 through 71 show screenshots from an embodiment of the client application described herein, such screenshots showing the features of, and the method of using, the invention disclosed herein as noted in the respective captions of such figures.

Certain embodiments may include advertisements displayed or otherwise distributed through the client application. Such advertisements may include visual and/or audible components and may or may not be displayed or otherwise distributed with regard to the location of users of the system. For example, in an embodiment, an advertisement for a event that is to occur at location A (e.g., a concert venue) may be displayed or otherwise distributed to a user of the system who is located near location A at a time prior to the occurrence of such advertised event, but not displayed or otherwise distributed to a user who is not located near location A. In additional embodiments, the selection of which advertisements are to be displayed or otherwise distributed to particular users of the system may give weight to the preferences or interests expressed by such users.

In an embodiment, advertisements may be displayed in the client application within a dedicated portion of the screen on which the client application is being displayed. In another embodiment, advertisements may be presented as graphical markers on the mapping interface provided within the client application. In such an embodiment, the user may be able to obtain additional information about such advertisement by selecting it from within the client application interface.

The pricing charged for such advertisements may take into account several location-based factors. In one embodiment, the cost charged to an advertiser may increase in relation to the number, or concentration, of advertisements to be displayed with respect to a specified locational area. For example, if there are 10 advertisements that are to be displayed near location A and 5 advertisements that are to be displayed near location B, a higher price may be charged to those advertisers who wish to display advertisements near location A. In another embodiment, the cost charged to an advertiser may increase in relation to the number, or concentration, of users of the system near the location at which such advertisement is to be displayed. For example, if there are 100 users near location X and 10 users near location Y, a higher price may be charged to those advertisers who wish to display advertisements near location X.

In another embodiment, advertisers may be permitted to bid different amounts to affect the probability that their advertisements will be displayed. For example, in such an embodiment, the system may limit the number of advertisements that will be displayed by the client application at a particular moment within a certain vicinity. If two advertisers wish to display advertisements to users who are near location Q, each such advertiser may be permitted to bid for the right to have its advertisement displayed at a greater frequency than the other's. In such an embodiment, the frequency with which an advertisement is displayed within the application may be related to the relative size of the bid submitted by the sponsoring advertiser.

In further embodiments, advertisers may be charged with respect to the number of users who interact with (or “click through”) their advertisements that may be displayed or otherwise distributed within the client application, including as graphical markers on the mapping interface provided within the client application.

What is claimed:

1. A system that enables users to know when other people to whom they are socially connected are nearby specified locations and to communicate with such people, without necessarily exposing the exact location of any user to any other user, the system comprising:
a remote operations center, which center is comprised of one or more servers that can connect to the internet or another network, which servers are comprised of one or more processors, memory, long-term storage devices, and network adapters connecting such servers to the internet or another network; and
client devices that can connect to the internet or such other network, which client devices run a client application and are comprised of one or more processors, memory, a long-term storage device, and one or more sensors from which the location of such device can be determined.

2. The system of claim 1, wherein each client device running the client application calculates the location of such device using one or more built-in sensors, which may include, but are not limited to, global positioning system sensors, cellular radio transmitters and receivers, Wi-Fi radio transmitters and receivers, and Bluetooth radio transmitters and receivers.

3. The system of claim 1, wherein, upon determining the location of the client device, the client device running the client application transmits such locational information, together with the identity of the account logged into the client application on such client device, over the internet or another network, to the system's server(s), which receive such data and log such data in a database.

4. The system of claim 3, wherein, upon a change in the location of a client device, such client device detects such change using one or more sensors and transmits such changed locational information, together with the identity of the account logged into the client application on such client device, over the internet or another network to the system's server(s), which receive such data and log such data in the database to update such database with respect to the location of the applicable client device.

5. The system of claim 1, wherein a user of the client application can specify within such application a query, comprising a center point and a radius defining a geographic area.

6. The system of claim 5, wherein the client application converts the center point and radius specified by the user into geographic coordinates and transmits such information to the server(s), which receive such query and process it.

7. The system of claim 6, wherein the processing of such query is comprised of:
accessing the system's database;
identifying those other users of the system who are denoted in the database as being connected to the querying user;
identifying, from within the list of those other users, those whose account settings permit the querying user to be informed of when such other users are nearby;
accessing the most recent locations of client devices associated with such subset of other users;
calculating which of those stored locations are within the geographic area specified by the query;
generating a list of the user accounts associated with such stored locations; and
transmitting such list to the client device of the querying user.

8. The system of claim 7, wherein, upon receipt of such list from the server(s), the client application running on the querying user's client device displays to the querying user an indication of the number and/or identity of such other users who have client devices for which the most recently stored locations are within the queried geographic area.

9. The system of claim 8, wherein each user of the client application can define one or more parameters to specify which other users can use the system to determine when he or she is likely located within a queried geographic area.

10. The system of claim 9, wherein the defined parameter(s) include:
the selection of whether such user should be included in vicinity queries performed by other users of the application;
the selection, on a user-by-user basis, of whether such user should be included in vicinity queries performed by particular other users;
the selection of whether such user should be included in vicinity queries when such user is located at one or more particular locations; or
the selection of whether such user should be included in vicinity queries conducted at particular times.

11. The system of claim 9, wherein each such parameter specified by a user is transmitted from such user's client application to the system's server(s), which parameter is then stored in the system's database.

12. The system of claim 4, wherein each user of the client application can specify one or more geographic locations to be stored in the system's database in relation to such user's account, as well as one or more time periods during which such specified geographic locations should be used by the system in place of any location detected by the user's client device.

13. The system of claim 1, wherein the client application and server(s) permit users to communicate with each other by transmitting messages, which messages may include text, video, audio, still images, or other digital data.

14. The system of claim 13, wherein a user may select one or more recipients within the client application, input message data into the client application, and command the client device to transmit such data to the system's server(s), which servers process such transmitted data by:
reading the identities of the intended recipients;
accessing the system's database of user accounts to determine which accounts are associated with the intended recipients;
retrieving from the database the identities of the client devices, if any, on which the user accounts of such intended recipients are logged in; and
transmitting such message data to such recipient client devices.

15. The system of claim 13, wherein each client device on which a recipient's user account is logged in that receives transmitted message data displays or otherwise makes available such message data to such recipient.

16. The system of claim 13, wherein the user can select within the client application whether a message to multiple recipients should be sent:
as a single group message to all recipients, such that each recipient can see the identities of the other recipients; or
as a series of individual messages, separately to each recipient, such that each recipient is not informed that any other recipient received the same message.

17. The system of claim 16, wherein:
for each message that a user sends as a group message to all recipients, the client device transmits the message data to the system's server(s), which create a group chat room for all of the recipients and which retransmit such message to the specified group of recipients; and
for each message that a user sends to multiple recipients separately, as an individual message to each recipient, the client device transmits the message data to the system's server(s), which retransmit such message to each specified recipient without creating a chat room for all recipients.

18. The system of claim 1, wherein the client application and server(s) permit users to transmit invitations to events.

19. The system of claim 18, wherein a user may select one or more recipients within the client application, input information about the applicable event into the client application, and command the client device to transmit such data to the system's server(s), upon receipt of which, such server(s) process such data by:
reading the identities of the intended recipients;
accessing the system's database of user accounts to determine which accounts are associated with the intended recipients;
retrieving from the database the identities of the client devices, if any, on which the user accounts of such intended recipients are logged in; and
transmitting such invitation data to such recipient client devices.

20. The system of claim 19, wherein, upon receipt of invitation data from the server(s), each receiving client device on which a recipient's user account is logged in displays or otherwise makes available such invitation data to such recipient.

21. The system of claim 18, wherein such invitations may include text, video, audio, still images, or other digital data.

22. The system of claim 1, wherein a sending user can transmit messages and invitations outside of the system by making use of one or more additional communication protocols.

23. The system of claim 22, wherein such additional communication protocols include SMS or email.

24. The system of claim 22, wherein such additional communication protocols include a protocol other than SMS or email.

25. The system of claim 22, wherein the client application running on the sender's client device may access the contact information stored on, or made available through, such device and may permit the sender to select recipients for whom he or she has contact information but who are not themselves users of the client application.

26. The system of claim 22, wherein the sender's message, invitation, or other data are transmitted over one or more of such other communication protocols according to an order of priority, which may be defined by the system design or by the sending user.

27. The system of claim 26, wherein the defined order of priority is:
first, such system's internal protocols;
second, SMS; and
third, email.

28. The system of claim 22, wherein the information upon which the selection of the utilized communication protocol is based is stored on, or made available through, the client device.

29. The system of claim 22, wherein the information upon which the selection of the utilized communication protocol is based is input by the user.

30. The system of claim 18, wherein the system permits users to publish or distribute invitations to events that are not restricted to specific invitees, which invitations may include text, video, audio, still images, or other digital data.

31. The system of claim 30, wherein, upon receipt by the system's server(s) of data regarding an invitation to such a public event, the system's server(s) store such data in the system's database.

32. The system of claim 30, wherein users of the client application can command the application to query the system for public events, including events relating to geographic locations specified by such users.

33. The system of claim 32, wherein:
upon receipt of such a query for public events, the system's server(s) access the system's database, search the database for public events satisfying the querying user's search criteria, and transmit to the querying user's client device data about any public events satisfying such user's search criteria; and
upon receipt of public event data, the receiving client device displays or otherwise makes available such public event data to such querying user.

34. The system of claim 1, wherein a user of the client application is denoted in the system's database as being connected to another user without requiring such user to send a connection request to, or take individual action with respect to, such other user.

35. The system of claim 34, wherein:
the client application accesses the list of contacts stored on, or made available through, the client device and transmits the telephone numbers and email addresses of such contacts to the system's server(s); and
upon receipt of telephone numbers or email addresses, the system's server(s) access the system's database to search for user accounts associated with any of such telephone numbers and email addresses.

36. The system of claim 35, wherein:
upon finding a received telephone number or email address that was already stored in the system's database, the server(s) query the database to determine whether the user whose account is associated with such phone number or email address had the transmitting user's telephone number or email address stored on, or made available through, his or her client device; and
the server(s) modify the database to denote as connected any two users who have each others' telephone numbers and/or email addresses stored in, or made available through, their respective client devices.

37. The system of claim 35, wherein the client application transmits to the server(s), and/or the server(s) store in the database, a hash of contact information, and database queries relating to stored contact information are performed with hashes of such contact information.

38. The system of claim 34, wherein the client application and/or server(s) access the user's connection list(s) on one or more social media platforms and transmit such information to the systems server(s).

39. The system of claim 38, wherein upon receipt of a user's social media platform connection list(s), the system's server(s) access the system's database to search for other user accounts associated with any users of such social media platforms listed in such connection list(s) and modify the system's database to denote as connected any two users who are connected on a social media platform.

40. The system of claim 38, wherein the client application transmits to the server(s), and/or the server(s) store in the database, a hash of any such social media platform information and database queries relating to stored social media platform information are performed with hashes of such information.

41. The system of claim 1, wherein a user sends requests from his or her client application, through the system's server(s), to other users of the client application, seeking permission to be connected to those other users, and a connection is denoted in the system's database with respect to a request-sender and a request-recipient if such request-recipient accepts such request.

42. The system of claim 1, wherein the client application or servers may display or otherwise distribute advertisements.

43. The system of claim 42, wherein the advertisements may include visual and/or audible components.

44. The system of claim 42, wherein the selection of advertisements displayed or otherwise distributed to users of the client application is influenced by the location of such users or by preferences or interests expressed by such users.

45. The system of claim 42, wherein the selection of advertisements displayed or otherwise distributed to users of the client application is not influenced by the location of such users or by preferences or interests expressed by such users.

46. The system of claim 42, wherein an advertisement is presented as a graphical marker on the mapping interface provided within the client application.

47. The system of claim 46, wherein information about the advertisement may be accessed by selecting the graphical marker representing such advertisement from within the client application interface.

48. The system of claim 42, wherein the price charged to an advertiser for an advertisement:
is related to one or more location-based factors;
increases in relation to the number, or concentration, of advertisements to be displayed within the client application with respect to a specified locational area;
increases in relation to the number, or concentration, of users of the client application near the location with respect to which such advertisement is to be displayed within the client application; or
is related to the number of client application users who interact with the advertisement that is displayed or otherwise distributed within the client application.

49. The system of claim 42, wherein the probability that an advertisement will be displayed is related to an amount bid by the sponsoring advertiser.

50. A method to enable users to know when other people to whom they are socially connected are nearby specified locations and to communicate with such people, without necessarily exposing the exact location of any user to any other user, the method comprising:
an application and service, wherein such application and service feature one or more methods of communication whereby users can communicate with other people through such application and service, including text, audio, or video communication;
wherein such application determines the location of the device on which it is running;
wherein, once determined, the location of such device is transmitted from such device to one or more servers, which servers log such location for such device;
wherein, as such device changes location, such application transmits updated location information to such servers, which in turn update databases employed in the claimed method to store current locational information regarding such device; and
wherein, such location determination, transmission, and recording occur without the need for a user to interact with the application in order to trigger any update or other posting or signaling of such user's location.

51. The method of claim 50, which method further comprises:
the creation of a user account by a user within the application and service;
the storage of information about each such user in one or more databases of the service;
providing a user with a means of selecting a center point and search radius;
transmitting such center point and search radius to one or more servers running the service;
the storage of such parameters on such servers;
the calculation of the area that is defined by such parameters;
accessing the database of users of the service to retrieve the location of those other users of the service who are denoted as connected to such querying user;
determining which of such other users of the service have current locations stored in the database that are within the area specified by the querying user;
and transmitting to the querying user's application the number of such other users who have current locations stored in the database that are within the area specified by the querying user.

52. The method of claim 51, wherein the number of such other users who are denoted as connected to the querying user and who have current locations stored in the database that are within the area specified by the querying user is presented by the application to the querying user:
visually as an integer;
visually as a colored or shaded layer overlaid upon a map interface; or
by some other visual, audible, or physical means.

53. The method of claim 52, wherein the visual interface of the application features a button that, when selected by the querying user, informs such user of the identity of those other users to whom he or she is denoted as connected who have current locations stored in the database that are within the area specified by the querying user.

54. The method of claim 51, wherein, in place of, or in addition to, automated location determination, the application permits a user to specify one or more alternate locations, and one or more time periods during which such alternate location(s) should be used, at which the service will treat the user as being located.

55. The method of claim 51, wherein the application facilitates communication among users by providing a messaging client, which allows users to send messages, including text, video, audio, still images, or other digital data, to other users, wherein such messages are sent from the device upon which the application is running to one or more remove servers, which servers in turn transmit such messages to the device(s), if any, running the application on which the user accounts of the message recipients are logged in.

56. The method of claim 51, wherein the application provides users with the ability to send and receive invitations to private and/or public events, wherein such invitations:
are sent from the device of the sender upon which the application is running or from another compatible application to one or more remote servers;
which servers in turn transmit such invitations to (1) in the case of private invitations, the device(s), if any, running the application on which the user accounts of the invitation recipients are logged in and (2) in the case of public invitations, all device(s) running the application which query such servers for public invitations associated with queried locations.

57. The method of claim 51, wherein the application facilitates communication among users by routing communications through protocols, such as SMS and email, other than any internal message client incorporated into the application so that users can, from within the application, send information, such as messages or invitations, to others who are not users of the application.

58. The method of claim 51, wherein a user of the application is denoted as being connected to another user without requiring such user to send a connection request to, or take individual action with respect to, such other user.

59. The method of claim 58, wherein the means used to determine which users of the service should be denoted as connected to a given user comprise:
the user permitting the application to access the phone numbers and email addresses stored on the user's device;
the application transmitting such information to one or more servers of the service, which may store such information in hash form;
such servers comparing such information, or a hash thereof, against such information, which may also be stored in hash form, provided to the service by other users; and
denoting as connected to each other those users who have each other's phone numbers and/or email addresses stored in their respective contacts lists.

60. The method of claim 58, wherein the means used to determine which users of the service should be denoted as connected to a given user comprise:
the user permitting the application to access the user's list of connections on a third-party social network;
the application transmitting such information to one or more servers of the service, which may store such information in hash form; and
denoting as connected to each other those users who are connected on such third-party social network.

61. The method of claim 51, wherein a user sends requests from his or her application to other users of the application, seeking permission to be connected to those other users, and a connection is denoted with respect to a request-sender and a request-recipient if such request-recipient accepts such request.

62. The method of claim 51, wherein those users of the service who are denoted as connected to a particular user are listed on a list, which list is displayed to such user within the interface of the application.

63. The method of claim 62, wherein the application permits the user to create one or more subcategories or sublists of other users.

64. The method of claim 51, wherein the application displays one or more listings of a user's contacts who are not themselves users of the service, or who are not denoted as connected to such user.

65. The method of claim 51, wherein the service automatically selects, from a specified array of options, the appropriate protocol through which to deliver messages, invitations, or other communications to each applicable recipient.

66. The method of claim 65, wherein:
for each recipient who is also a user of the application and service, the service routes the underlying communication internally through the service's servers to the messaging client or invitation system incorporated into the application installed on the recipient's device or devices;
for each recipient who is not denoted as connected to the sender but for whom the sender has a telephone number, the service routes the underlying communication through SMS; and
for each recipient who is not denoted as connected to the sender and for whom the sender does not have a telephone number but for whom the sender has an email address, the service routes the underlying communication through email to the email address of the recipient.

67. The method of claim 65, wherein the user of the application selects the order in which protocols of communication are to be prioritized or utilized.

68. The method of claim 51, wherein a user sending an invitation through the service may specify whether the event relating to such invitation is private or public, and wherein:
the service sends invitations to private events only to the recipients specified by the sender; and
invitations to public events are viewable by all users of the application by visual review or search of: a listing of invitations to public events that the application displays to users or a mapping interface within the application, upon which public events are marked by visual elements overlaid on the map location of the applicable event.

69. The method of claim 51, wherein, the application and service enable a user to choose whether to send a message to multiple recipients:
as a single group message to all recipients, such that each recipient can see the identities of the other recipients; or
as a series of individual messages, separately to each recipient, such that each recipient is not informed that any other recipient received the same message.

70. The method of claim 51, wherein the application and service enable a user to define the degree to which he or she shares his or her vicinity information with other users of the application and service.

71. The method of claim 70, wherein a user may define the degree of such vicinity information sharing by:
preventing himself or herself from appearing in all vicinity searches conducted by other users of the application and service;
selecting, on a user-by-user basis, to which other users of the application and service he or she will appear in vicinity searches conducted by such other users;
specifying one or more locations at which such user will not appear in vicinity searches conducted by some or all other users of the application and service; or
specifying one or more time periods during which such user will not appear in vicinity searches conducted by some or all other users of the application and service.
